(19) United States
(12) Patent Application Publication
(10) Pub. No.: US 2023/0348309 A1
(43) Pub. Date: Nov. 2, 2023

(54) METHOD FOR PRODUCING AN OPTICAL ELEMENT MADE OF GLASS

(71) Applicant: Docter Optics SE, Neustadt an der Orla (DE)

(72) Inventors: Alexander KUPPE, Neustadt an der Orla (DE); Annegret DIATTA, Neustadt an der Orla (DE)

(73) Assignee: Docter Optics SE, Neustadt an der Orla (DE)

(21) Appl. No.: 18/245,396

(22) PCT Filed: Oct. 19, 2021
(86) PCT No.: PCT/DE2021/100840

§ 371 Date: Mar. 15, 2023

(30) Foreign Application Priority Data
Oct. 20, 2020 (DE) 10 2020 127 639.7
Feb. 1, 2021 (DE) 10 2021 102 289.4

(51) Int. Cl. C03B 11/08; C03B 11/12; C03B 35/00

(52) U.S. Cl. CPC C03B 11/08; C03B 11/122; C03B 11/125; C03B 35/005; C03B 2215/46; C03B 2215/61

(57) ABSTRACT

The disclosure relates to a method for producing an optical element, for example an (optical) lens, for example a headlight lens, for example a vehicle headlight lens, from inorganic glass, wherein a blank of the inorganic glass is heated in a first heating step, for example in such a way that the blank is cooler on the inside than on its outer region, wherein, after heating, the blank is press-molded, for example on both sides, in a first pressing step between an upper mold and a lower mold to form an intermediate molded part, wherein the intermediate molded part is removed from the lower mold after the first pressing step, wherein a surface or the surface of the intermediate molded part formed by the lower mold and/or the surface of the intermediate molded part facing the lower mold is heated in a second heating step after the first pressing step, wherein the intermediate molded part is press-molded, for example on both sides, to the optical element or the (optical) lens, in a second pressing step after the second heating step, and wherein the optical element or the (optical) lens is cooled in a cooling path after the second pressing step.

### FIELD OF THE DISCLOSURE

The disclosure relates to a method of press-molding an optical element or (optical) lens of (inorganic) glass using a blank of (inorganic) glass.

### BACKGROUND

EP 2 104 651 B1 relates to a method of manufacturing headlight lenses for vehicle headlights, wherein a headlight lens comprises a lens body of glass having a substantially flat surface and a convexly curved surface, wherein a preform is press-molded between a lower mold for pressing the convexly curved surface and an upper mold for pressing the substantially flat surface, comprising a first part mold and an annular second part mold surrounding the first part mold, to form a headlight lens having an integrally formed lens edge, wherein a step is pressed into the headlight lens by an offset between the second part mold and the first part mold depending on the volume of the preform, and wherein the first part mold is set back relative to the second part mold at least in the region of the offset.

WO 2019/072325 A1 relates to a method for producing an optical element from glass, wherein a portion of glass or a blank of glass is press-molded to form the optical element, for example on both sides, wherein the optical element is subsequently deposited on a transport element and passes through a cooling path with the transport element, without touching an optical surface of the optical element.

WO 2019/072326 A1 relates to a process for producing an optical element from glass, wherein a blank of glass is placed on an annular support surface of a supporting body with a hollow cross-section and is heated on the supporting body, for example in such a way that a temperature gradient is established in the blank such that the blank is cooler in the inside than in its outer region, wherein the support surface is cooled by means of a cooling medium flowing through the supporting body, wherein the blank of glass after heating is press-molded, for example on both sides, to the optical element, wherein the support surface spans a base area which is not circular.

### SUMMARY

The present disclosure relates to a method of manufacturing an optical element, for example an (optical) lens, for example a headlight lens, for example a vehicle headlight lens, from (inorganic) glass according to the claims. In this context, it is provided for example that a blank of the (inorganic) glass is heated in a first heating step, for example in such a way that the blank is cooler in the inside than in its outer region, wherein the blank, after heating, is press-molded for example to obtain an intermediate molded part, wherein the intermediate molded part is press-molded, for example on both sides, to the optical element or the (optical) lens.

### BRIEF DESCRIPTION OF THE DRAWINGS

FIG. 1 shows a device shown in principle for producing motor vehicle headlight lenses or lens-like free forms for motor vehicle headlights or optical elements made of glass,

FIG. 1A shows a device shown in principle for producing gobs or optical elements made of glass,

FIG. 1B shows a device shown in principle for producing motor vehicle headlight lenses or lens-like free-forms for motor vehicle headlights or optical elements made of glass,

FIG. 2A shows an exemplary sequence of a method for producing motor vehicle headlight lenses or lens-like free-forms for a motor vehicle headlight or optical elements made of glass,

FIG. 2B shows an alternative exemplary sequence of a method for producing motor vehicle headlight lenses or lens-like free-forms for a motor vehicle headlight or optical elements made of glass,

FIG. 3 shows an embodiment of a lance,

FIG. 4 shows another embodiment of a lance,

FIG. 5 shows an exemplary preform before entering a temperature control unit,

FIG. 6 shows an exemplary preform with an inverted temperature gradient after leaving a temperature control unit,

FIG. 7 shows an embodiment for a transport element,

FIG. 8 shows an embodiment of a heating apparatus for a transport element according to FIG. 7,

FIG. 9 shows an example of removing a transport element according to FIG. 7 from a heating apparatus according to FIG. 8,

FIG. 10 shows a headlight lens on a transport element according to FIG. 7,

FIG. 11 shows another embodiment of a transport element,

FIG. 12 shows the transport element according to FIG. 11 in a cross-sectional view

FIG. 13 shows an embodiment of a cooling path in principle,

FIG. 14 shows a lance according to FIG. 3 in a hood-type annealing furnace with a protective cap for heating a gob.

FIG. 15 shows a view of the hood-type annealing furnace according to FIG. 14 from below,

FIG. 16 shows a cross-section through the protective cap according to FIG. 14,

FIG. 17 shows a view inside the protective cap according to FIG. 14,

FIG. 18 shows a perspective view of the protective cap according to FIG. 14,

FIG. 19 shows a cross-section through another protective cap,

FIG. 20 shows a view inside the protective cap according to FIG. 19,

FIG. 21 shows a cross-section through another protective cap,

FIG. 22 shows a view inside the protective cap according to FIG. 21,

FIG. 23 shows a perspective view of the protective cap according to FIG. 21,

FIG. 24 shows a press station shown in principle for pressing a headlight lens from a heated blank,

FIG. 25 shows another embodiment of a press station,

FIG. 26 shows a detail of a press station and

FIG. 27 shows a press station shown in principle modified from the press station shown in FIG. 24 for pressing a headlight lens from a heated blank,

FIG. 28 shows a detailed view of the press station according to FIG. 27,

FIG. 29 shows a principle sketch for explaining tilt and radial offset in relation to the upper mold,

FIG. 30 shows a principle sketch explaining tilt and radial offset in relation to the lower mold,

FIG. 31 shows an embodiment of a decoupling element in relation to torsion,

FIG. 32 shows an embodiment of a modification of the press station according to FIG. 24,

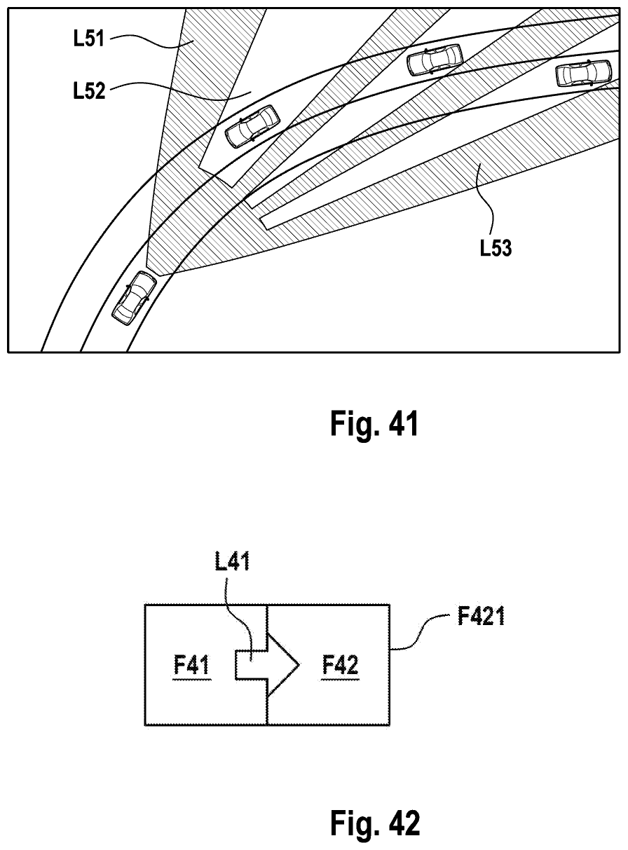

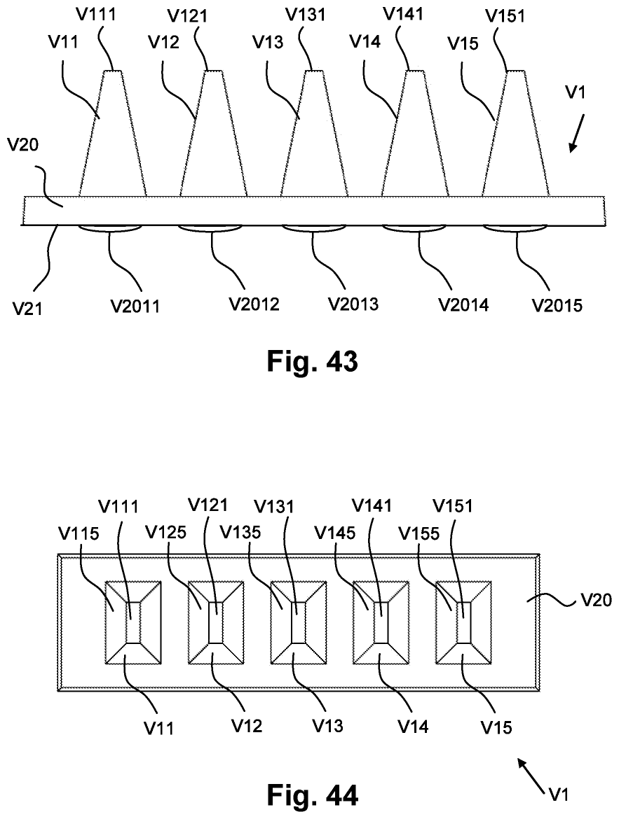

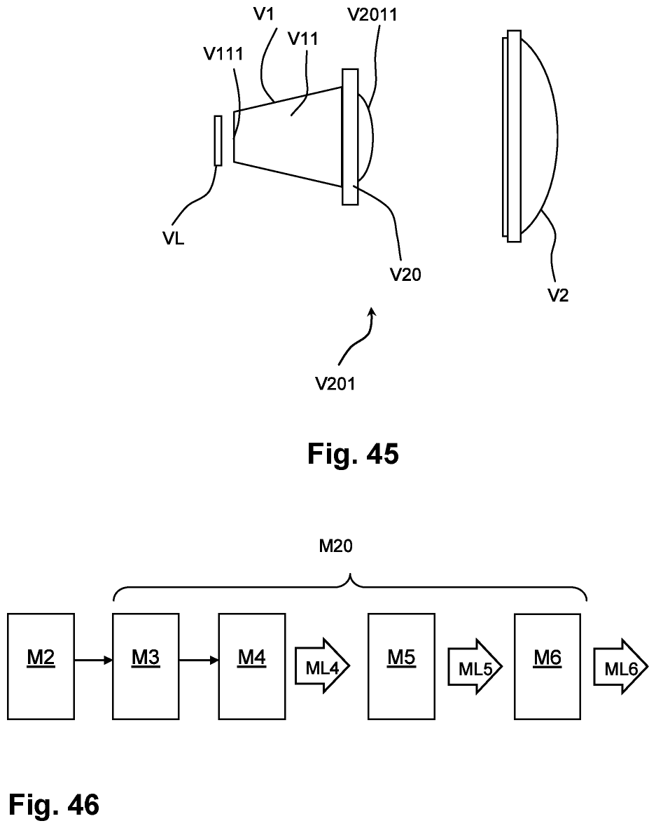

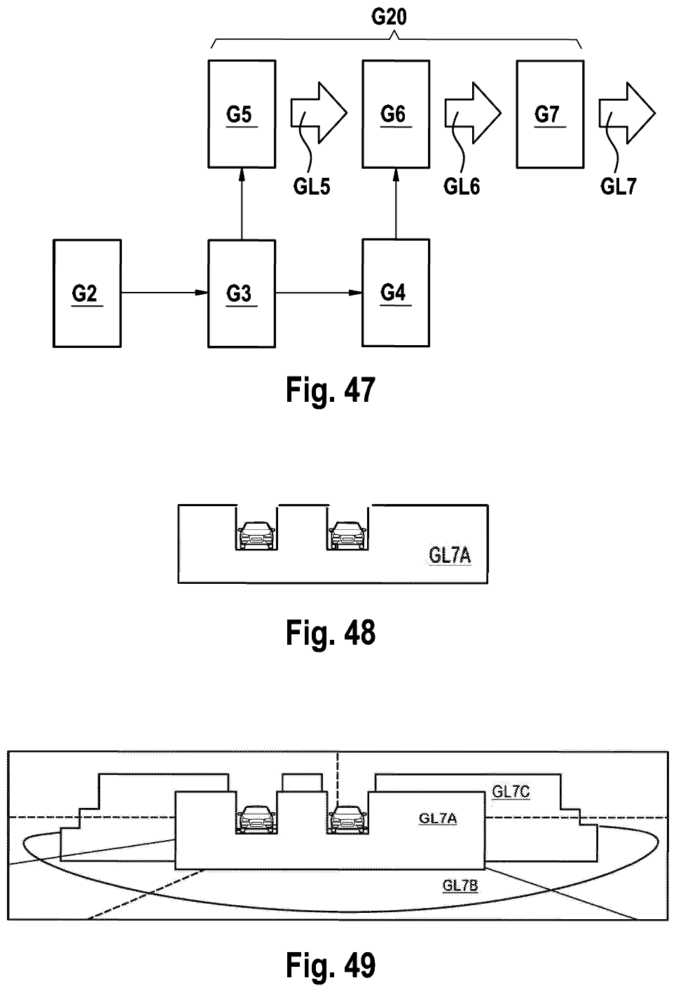

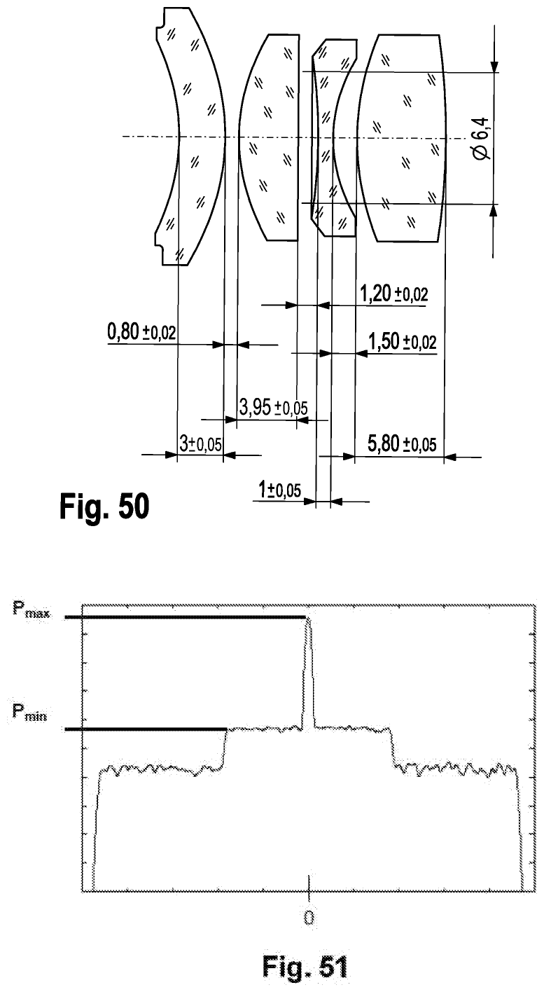

FIG. 25, FIG. 26, FIG. 27 and FIG. 28 for pressing under vacuum or near-vacuum or negative pressure explained by means of a modified representation of the principle sketch according to FIG. 24,

FIG. 33 shows an embodiment of a surface treatment station in a cross-sectional view.

FIG. 34 shows a motor vehicle headlight (projection headlight) with a headlight lens shown in principle,

FIG. 35 shows a headlight lens according to FIG. 34 in a view from below,

FIG. 36 shows a cross-sectional view of the lens according to FIG. 35

FIG. 37 shows a section of the view according to FIG. 36,

FIG. 38 shows the detail according to FIG. 37 with a sectional view of the transport element (in cross-sectional view),

FIG. 39 shows an embodiment of a vehicle headlight in a schematic diagram,

FIG. 40 shows an embodiment for matrix light or adaptive high beam,

FIG. 41 shows another embodiment for matrix light or adaptive high beam,

FIG. 42 shows an example of an illumination device of a vehicle headlight according to FIG. 39,

FIG. 43 shows an embodiment of an attachment optics array in a side view,

FIG. 44 shows the attachment optics array of FIG. 43 in a top view and,

FIG. 45 shows the use of an attachment optics array according to FIG. 43 and FIG. 44 in a motor vehicle headlight,

FIG. 46 shows another embodiment of an alternative vehicle headlight,

FIG. 47 shows another embodiment of an alternative vehicle headlight,

FIG. 48 shows an example of illumination by means of a headlight according to FIG. 47,

FIG. 49 shows an embodiment for superimposed illumination using the illumination according to FIG. 48 and the illumination of two further headlight systems or subsystems,

FIG. 50 shows an embodiment of an objective, and

FIG. 51 shows light power logarithmically plotted against the distance from a point under consideration of an object,

FIG. 52 shows a projection display with a microlens array with a curved base,

FIG. 53 shows a clamping arrangement with a flat preform,

FIG. 54 shows a microlens array with a round carrier

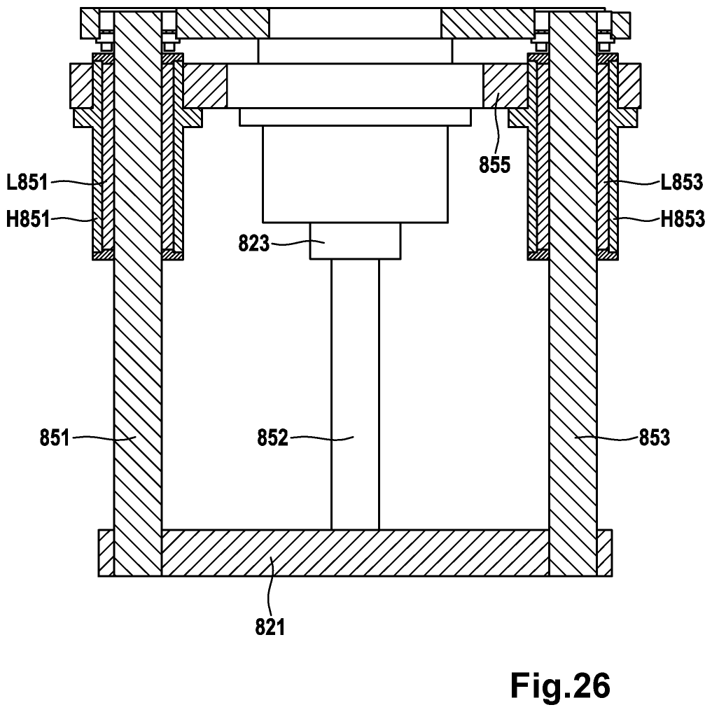

FIG. 55 shows an embodiment, modified from the embodiment shown in FIG. 14, for heating a blank in a hood-type annealing furnace using a lower mold part and a cooling block,

FIG. 56 shows an embodiment of transporting a heated blank in a housing to mitigate cooling of a blank during transport from a hood-type annealing furnace to a press station,

FIG. 57 shows an embodiment of pressing a blank using a lower mold comprising a first lower mold part and a second lower mold part,

FIG. 58A shows the pressing of an intermediate molded part from a blank by completely moving a lower mold and an upper mold toward each other or completely closing a cavity formed by an upper mold and a lower mold,

FIG. 58B shows the pressing of an intermediate molded part from a blank by not completely closing a lower mold and an upper mold to each other or not completely closing a cavity formed by an upper mold and a lower mold,

FIG. 59 shows an embodiment of heating a side of an intermediate molded part facing a lower mold,

FIG. 60 shows an embodiment of pressing an optical element from an intermediate molded part,

FIG. 61 shows an embodiment of moving apart a lower mold and an upper mold to open a cavity for pressing an optical element,

FIG. 62 shows an embodiment of cooling an optical element in a cooling path, wherein the optical element rests on a lower mold part, and

FIG. 63 shows an embodiment of a biconvex lens.

### DETAILED DESCRIPTION

The present disclosure relates to a method of manufacturing an optical element, for example an (optical) lens, for example a headlight lens, for example a vehicle headlight lens, from (inorganic) glass according to the claims. In this context, it is provided for example that a blank of the (inorganic) glass is heated in a first heating step, for example in such a way that the blank is cooler in the inside than in its outer region, wherein the blank, after heating, is press-molded, for example on both sides, in a first pressing step between an upper mold and a lower mold to form an intermediate molded part, wherein the intermediate molded part is removed from the lower mold after the first pressing step, wherein one or the surface of the intermediate molded part formed by the lower mold and/or the surface of the intermediate molded part facing the lower mold is heated in a second heating step after the first pressing step, wherein the intermediate molded part is press-molded, for example on both sides, to the optical element or the (optical) lens, in a second pressing step after the second heating step, and wherein the optical element or the (optical) lens is cooled in a cooling path after the second pressing step. In a further embodiment, the lower mold has a first lower mold part and at least one second lower mold part, for example enclosing the first lower mold part, for example at least partially.

In a further embodiment, the (optical) lens has a convexly curved optically effective surface and a planar surface. In a further embodiment, the (optical) lens has a first convexly curved optically effective surface and a second convexly curved optically effective surface, wherein it may be provided that the diameter of the first convexly curved optically effective surface is greater than the diameter of the second convexly curved optically effective surface. It may be provided that the lens comprises an integrally formed edge (having a volume). It may further be provided that a step is provided between the integrally formed lens edge and the second optically effective surface. The step may be configured to taper toward the second optically effective convexly curved surface. In this regard, the taper may be at a typical demolding angle. For example, a suitable angle is greater than 3 degrees. It may be provided that the height of the step is subject to tolerance to accommodate variations in gob volume. However, it may also be provided that the thickness of the formed lens edge, i.e. its extension in orientation of the optical axis of the lens, is subject to tolerances. This is for example the case, or is provided for, if the upper mold and/or the lower mold is designed in at least two parts. It may be provided that the upper mold has a first upper mold part and a second upper mold part comprising for example the first upper mold part, for example at least partially. The method described is for example suitable for pressing biconvex lenses. For example, the method is particularly suitable for pressing biconvex lenses as disclosed in WO 2007/031170 A1.

In a further embodiment, the blank is heated in the first heating step on and/or in the lower mold and/or on the first lower mold part (lying).

In a further embodiment, the blank is heated in the first heating step in such a way that immediately before pressing the blank is no more than 100 K colder on its bottom side than on its top side. The temperature difference between the top side and the bottom side of the blank is thus no more than 100 K immediately before pressing.

In a further embodiment, the blank is held on the lower mold or the first lower mold part for heating in connection with the first heating step or during the first heating step. For example, it is provided that the bottom side of the blank is planar or has a radius of curvature that is larger than the radius of curvature of the concavely shaped lower mold or the concavely shaped first lower mold part. The blank resting on the lower mold or the first lower mold part can be heated by means of a hood-type annealing furnace. For example, it is provided that the blank rests on the surface provided for forming the intermediate molded part.

A cooling block can be provided for cooling the lower mold or the first lower mold part in connection with the first heating step or during the first heating step. This cooling block can be cooled for cooling the lower mold or the first lower mold part by means of a cooling channel. At least one temperature sensor may be provided for controlling the cooling. In an embodiment, several, but at least two, (independent) cooling channels are provided in the cooling block, which can be set independently of one another or whose flows can be set independently of one another. For example, it is provided that the independent adjustability serves to form a desired temperature distribution in the cooling block and/or in the lower mold or the first lower mold part. More than two cooling channels may be provided which are independently adjustable. The independence of the two cooling channels and possible further cooling channels from each other relates (or may relate), among other things, to the cooling medium, the coolant quantity, the coolant speed and/or the coolant temperature.

In one embodiment, a housing may be provided in which the heated blank is transported on the lower mold or the first lower mold part for pressing (first pressing step). In this way, undesired cooling of the blank between heating (e.g. in a hood-type annealing furnace) and the pressing unit or press is reduced or avoided.

In one embodiment, the blank is placed on an annular support surface of a supporting body with a hollow cross section and heated on the supporting body in the first heating step. For example, the support surface is cooled by means of a cooling medium flowing through the supporting body.

In one embodiment, the upper mold and the lower mold are moved towards each other in the first pressing step, for example in such a way that the upper mold and the lower mold touch each other or that the upper mold and the lower mold do not touch each other or the upper mold and the second lower mold part do not touch each other. It may be provided that a gap remains between the upper mold and the lower mold, which gap is not undercut. For example, the gap or the gap height is at least 0.5 mm. In a further embodiment, it may be provided that the gap or the gap height is at least 2 mm. In a further embodiment, it may be provided that the gap or the gap height is at least 3 mm. However, it is for example intended that the gap or the gap height is not greater than 10 mm.

The bottom side of the blank is formed in the first pressing step by means of the lower mold. For example, it is intended that the bottom side of the intermediate molded part is formed by means of the lower mold.

The top side of the blank is formed in the first pressing step by means of the upper mold. For example, the top side of the intermediate molded part is formed by means of the upper mold.

In a further embodiment, the intermediate molded part is removed from the lower mold by means of the upper mold. In one embodiment, the upper mold and the lower mold are moved apart after the first pressing step. In this case, it is provided, for example, that the intermediate molded part is removed from the lower mold by means of a vacuum in a channel of the upper mold, which is not shown.

After the intermediate molded part has been removed from the lower mold, it can be provided that the intermediate molded part is heated on the side facing the lower mold by means of a heating device in a second heating step. This heating can be carried out, for example, by a gas flame or by means of heating coils.

In a further embodiment, the intermediate molded part is held in the second heating step by means of the upper mold, for example directly above the lower mold.

It can be provided that the heating device has a dual function for implementing the second heating step. This is done, for example, in connection with the second heating step or during the second heating step when the lower mold or the first lower mold part remains in the press. For example, the heating device for implementing the second heating step can be provided both for heating the bottom side of the intermediate molded part and for heating the lower mold or the first lower mold part (and, if applicable, also the lower mold or the first lower mold part before receiving an intermediate molded part) before receiving the blank. The heating device for implementing or performing the second heating step may be, for example, an induction heater or a radiant heater.

In a further embodiment, the press-molding is performed in the second pressing step by means of the upper mold.

In a further embodiment, the press-molding in the second pressing step is carried out by means of the (same) lower mold. It may also be provided that the lower mold in the second pressing step is a different lower mold than the lower mold in the first pressing step. However, the lower mold can be of the same design.

To carry out the second pressing step, the upper mold and the lower mold can be moved towards each other again. For example, it is intended that a closed cavity is formed by the lower mold and the upper mold. For this purpose, the upper mold and the lower mold are moved towards each other in such a way that they touch (and thus form a closed mold or cavity). For example the heated lower side or lower surface of the intermediate molded part is formed into the optically effective surface of the optical element by e.g. providing subsequent pressing by means of the lower mold. The second pressing step is followed by a process step in which the lower mold and the upper mold are moved apart.

In a further embodiment, the optical element or the (optical) lens is transferred to a cooling path on and/or in the lower mold and/or on the first lower mold part (lying). It can be provided that the optical element or the (optical) lens passes through the cooling part on and/or in the lower mold and/or on the first lower mold part (lying).

In another embodiment, the optical element is deposited on a transport element after the press-molding or after the second pressing step and passes through the cooling path with the transport element, without touching an optical surface of the optical element.

A cooling path (for example for cooling optical elements) within the meaning of this disclosure serves for example for the controlled cooling of the optical element (for example in accordance with a cooling regime and/or with the addition of heat). Exemplary cooling regimes can be taken from e.g. “Werkstoffkunde Glas”, 1st edition, VEB Deutscher Verlag für Grundstoffindustrie, Leipzig VLN 152-915/55/75, LSV 3014, editorial deadline: 1. 9.1974, order number: 54107, e.g. page 130 and “Glastechnik—BG 1/1—Werkstoff Glas”, VEB Deutscher Verlag für Grundstoffindustrie, Leipzig 1972, e.g. pages 59-65 (incorporated by reference in its entirety).

In a further embodiment, the lower mold is moved by means of an actuator for moving the lower mold in that the lower mold and the actuator are connected by means of a first movable guide rod and at least one second movable guide rod, for example at least one third movable guide rod, wherein the first movable guide rod is guided in a (first) recess of a fixed guide element and the second movable guide rod is guided in a (second) recess of the fixed guide element and the optional third movable guide rod is guided in a (third) recess of the fixed guide element, wherein for example it is provided that the lower mold is connected to the first movable guide rod and/or the second movable guide rod and/or the optional third movable guide rod by means of a movable connector, wherein for example it is provided that the deviation of the position of the lower mold orthogonal to the direction of movement of the lower mold is not more than 20 μm, for example not more than 15 μm, for example not more than 10 μm, from the target position of the lower mold orthogonal to the direction of movement of the lower mold.

In a further embodiment, the upper mold is moved by means of an actuator for moving the upper mold in a frame which comprises a first fixed guide rod, at least one second fixed guide rod and, for example, at least one third fixed guide rod, the first fixed guide rod, the at least second fixed guide rod and the optional at least third fixed guide rod being connected at one end by an actuator-side fixed connector and at the other end by a mold-side fixed connector, at least the upper mold being fixed to a movable guide element, which has a (first) recess through which the first fixed guide rod is guided, a further (second) recess through which the at least second fixed guide rod is guided, and optionally a further (third) recess through which the optionally third fixed guide rod is guided, wherein for example it is provided that the deviation of the position of the upper mold orthogonal to the direction of movement of the upper mold is not more than 20 μm, for example not more than 15 μm, for example not more than 10 μm, from the target position of the upper mold orthogonal to the direction of movement of the upper mold. At least the upper mold can be fixed to the moveable guide element by means of a mold holder. This may result in a distance between the upper mold and the movable guide element. In one embodiment, this distance is no greater than 150 mm, for example no greater than 100 mm, for example no greater than 50 mm.

In a further embodiment, it is provided for example that the lower mold is moved by means of an actuator for moving the lower mold in that the lower mold and the actuator for moving the lower mold are connected by means of a first movable guide rod and at least one second movable guide rod, for example at least one third movable guide rod, wherein the first movable guide rod is guided in a (first) recess of a fixed guide element and the second movable guide rod is guided in a (second) recess of the fixed guide element and the optional third movable guide rod is guided in a (third) recess of the fixed guide element, wherein it is provided for example that the lower mold is connected by means of a connector to the first movable guide rod and/or the second movable guide rod and/or the optional third movable guide rod.

In a further embodiment, the blank is press-molded, for example on both sides, after heating and/or after being provided between the lower mold and the at least upper mold to form the optical element, in such a way that the deviation of the position of the lower mold and/or of the upper mold orthogonal to the (target) pressing direction or (target) movement direction of the lower mold and/or of the upper mold is not more than 20 μm, for example no more than 15 μm, for example no more than 10 μm, from the target position of the lower mold and/or the upper mold orthogonal to the (target) direction of pressing or (target) direction of movement of the lower mold and/or the upper mold.

In a further embodiment, the blank of glass is press-molded, for example on both sides, after heating and/or after being provided between the lower mold and at least the upper mold to form the optical element in such a way that one or the angle between the target pressing direction of the lower mold and the actual pressing direction of the lower mold is not greater than 10⁻²° for example is not greater than 5.10⁻³°.

In a further embodiment, the blank of glass is press-molded, for example on both sides, after heating and/or after being provided between the lower mold and at least the upper mold to form the optical element in such a way that one or the angle between the target pressing direction of the upper mold and the actual pressing direction of the upper mold is not greater than 10⁻²° for example is not greater than 5·10⁻³°.

In a further embodiment, the blank of glass is press-molded, for example on both sides, after heating and/or after being provided between the lower mold and at least the upper mold to form the optical element in such a way that the first actuator is decoupled with respect to torsion from the mold-side movable connector and/or the lower mold (for example by means of a decoupling piece which comprises, for example, a ring and/or at least a first washer and optionally at least one second washer, wherein it may be provided that the ring comprises the first and/or second washer).

In a further embodiment, the blank of glass is press-molded, for example on both sides, after heating and/or after being provided between the lower mold and at least the upper mold to form the optical element in such a way that the second actuator is decoupled with respect to torsion from the mold-side moveable guide element and/or the upper mold (for example, by means of a decoupling piece comprising, for example, a ring and/or at least a first washer and optionally at least a second washer, wherein it may be provided that the ring comprises the first and/or second washer).

In a further embodiment, it is provided that the fixed guide element is the same as the mold-side fixed connector or is fixed directly or indirectly thereto.

In further embodiment, the maximum pressure with which the lower mold and the upper mold are pressed together is not less than 20,000 N.

In a further embodiment, the maximum pressure with which the lower mold and the upper mold are pressed together is not more than 100,000 N.

In a further embodiment, the maximum pressure with which the lower mold and the upper mold are pressed together is no more than 200,000 N.

In a further embodiment, the blank of glass is placed on a, for example annular, support surface of a supporting body, for example with a hollow cross section, and is heated on the supporting body in a cavity of a protective cap arranged in a furnace cavity, for example in such a way that a temperature gradient is established in the blank in such a way that the blank is cooler on the inside than in and/or on its outer region, the blank of glass being press-molded to the optical element, for example on both sides, after heating.

In a further embodiment, the protective cap is removably disposed in the furnace cavity.

In a further embodiment, the protective cap is removed from the furnace cavity after bursting of one or the blank, wherein for example. another protective cap is arranged in the furnace cavity.

In one embodiment, the blank is moved into the cavity of the protective cap from above or from the side. In a further embodiment, however, the blank is moved into the cavity of the protective cap from below.

In a further embodiment, the oven cavity comprises at least one heating coil which (at least partially) surrounds the protective cap in the oven cavity, wherein it is provided that the interior of the protective cap is heated by means of the at least one heating coil.

In a further embodiment, the oven cavity comprises at least two independently controllable heating coils which at least partially surround the protective cap in the oven cavity, wherein the interior of the protective cap is heated by means of the at least two heating coils.

In a further embodiment, the protective cap is made of silicon carbide or at least comprises silicon carbide.

In a further embodiment, the furnace cavity is part of a furnace arrangement, for example in the form of a carousel, with a plurality of furnace cavities, in each of which a protective cap is arranged. The rapid interchangeability of the protective caps when a blank bursts not only shortens the downtime, thereby reducing costs, but also improves the quality of the optical component, since the rapid interchangeability reduces interference during heating or heating of the blanks. This effect can be further improved by the fact that the opening of the cavity of the protective cap, which faces downward, is closed or partially closed by a closure, the closure being releasable and removable by loosening a fixing means, such as one or more screws. In this context, it is for example intended that the protective cap falls out of the furnace cavity after the lower cover has been loosened or removed. In this way, a particularly fast restoration of a furnace or a hood-type annealing furnace is ensured.

In a further embodiment, the support surface is cooled by means of a cooling medium flowing through the supporting body. In a further embodiment, the support surface has a base area that is not circular. For example, a geometry of the support surface or a geometry of the base area of the support surface is provided which corresponds to the geometry of the blank (which is to be heated), the geometry being selected in such a way that the blank rests on the outer region of its bottom side (bottom side base surface). The diameter of the bottom side or the bottom side base surface of the blank is at least 1 mm larger than the diameter of the spanned base surface (by the supporting body or its supporting surface). In this sense, it is for example provided that the geometry of the surface of the blank facing the supporting body, respectively the bottom side base surface of the blank, corresponds to the support surface, respectively the base area of the supporting body. This means for example that the part of the blank which rests on the supporting body or touches the supporting body during heating is arranged after the forming process or after pressing or after press-molding in an edge region of the headlight lens which lies outside the optical path and which rests for example on a transport element (see below) or its (corresponding) support surface.

An annular support surface may have small interruptions. A base area within the meaning of the present disclosure comprises, for example, an imaginary surface (in the region of which the blank resting on the supporting body is not in contact with the supporting body) which lies in the plane of the support surface and is enclosed by this support surface, and the (actual) support surface. For example, it is intended that the blank and the supporting body are matched to each other. This means for example that the blank rests with its edge region on the supporting body on its bottom side. An edge area of a blank can be understood to mean, for example, the outer 10% or the outer 5% of the blank or its bottom side.

In a further embodiment, the base surface is formed polygonal or polygonal, but for example with rounded corners, it being provided for example that the bottom side base surface of the blank is also formed polygonal or polygonal, but for example with rounded corners. In a further embodiment, the base surface is formed triangular or triangular, but for example with rounded corners, it being provided for example that the bottom side base surface of the blank is also formed triangular or triangular, but for example with rounded corners. In one embodiment, the base surface is formed rectangular or rectangular, but for example with rounded corners, it being provided for example that the bottom side base surface of the blank is also formed rectangular or rectangular, but for example with rounded corners. In a further embodiment, the base surface is square, but for example with rounded corners, it being provided for example that the bottom side base surface of the blank is also square, but for example with rounded corners. In a further embodiment, the base surface is oval, it being provided for example that the bottom side base surface of the blank is also oval.

In a further embodiment, the supporting body is tubular at least in the area of the supporting surface. The supporting body consists (at least essentially), for example, of steel or high-alloy steel (i.e., for example, a steel in which the average mass content of at least one alloying element is ≥5%) or of a tube made of steel or high-alloy steel. In a further embodiment, the diameter of the hollow cross-section of the supporting body or the tube inner diameter is not less than 0.5 mm and/or not greater than 1 mm, at least in the region of the support surface. In a further embodiment, the outer diameter of the supporting body or the tube outer diameter is not less than 2 mm and/or not greater than 4 mm, for example not greater than 3 mm, at least in the region of the support surface. In a further embodiment, the radius of curvature of the support surface orthogonal to the direction of flow of the coolant is not less than 1 mm and/or not greater than 2 mm, for example not greater than 1.5 mm. In a further embodiment, the ratio of the diameter of the hollow cross-section of the supporting body at least in the region of the support surface to the outer diameter of the supporting body at least in the region of the support surface is not less than ¼ and/or not greater than ½. In a further embodiment, the supporting body is uncoated at least in the region of the support surface. In a further embodiment, coolant flows through the supporting body in countercurrent flow. In a further embodiment, the coolant is additionally or actively heated. In a further embodiment, the supporting body comprises at least two flow channels for the coolant flowing through, each of which extends only over a portion of the annular support surface, it being provided for example that two flow channels are connected with metallic filler material, for example solder, in a region in which they leave the support surface.

A blank within the meaning of the present disclosure is, for example, a portioned glass part or a preform or a gob.

The process described can also be carried out in conjunction with pressing under vacuum or near-vacuum or at least negative pressure. Negative pressure in the sense of this disclosure is for example a pressure which is not greater than 0.5 bar, for example not greater than 0.3 bar, for example not less than 0.1 bar, for example not less than 0.2 bar. Vacuum or near-vacuum in the sense of this disclosure is for example a pressure which is not greater than 0.1 bar, for example not greater than 0.01 bar, for example not greater than 0.001 bar. Vacuum or near-vacuum in the sense of this disclosure is for example a pressure that is not less than 0.01 bar, for example not less than 0.001 bar, for example not less than 0.0001 bar. Suitable methods are disclosed, for example, in JP 2003-048728 A (incorporated by reference in its entirety) and in WO 2014/131426 A1 (incorporated by reference in its entirety). In a corresponding embodiment, a bellows as disclosed at least in a similar manner in WO 2014/131426 A1 may be provided. It may be provided that the pressing of the optical element is performed in such a way by means of the lower mold and the upper mold,
(a) wherein a heated blank of transparent material is placed in or on the lower mold,
(b) wherein (subsequently or thereafter) the upper mold and the lower mold are (to each other positioned and) moved toward each other without the upper mold and the lower mold forming a closed overall mold,
(c) wherein (subsequently or thereafter) a seal is closed to create an airtight space in which the upper mold and the lower mold are disposed,
(d) wherein (subsequently or thereafter) a negative pressure or near vacuum or vacuum are created in the airtight space,
(e) and wherein (subsequently or thereafter) the upper mold and the lower mold are moved (for example vertically) towards each other for (for example two-sided or all-sided) (press-) molding of the optical (lens) element, wherein it is provided for example that the upper mold and the lower mold form a closed overall mold.

The upper mold and the lower mold can be moved towards each other by moving the upper mold towards the lower mold and/or the lower mold towards the upper mold (vertically).

For pressing, the upper mold and the lower mold are moved towards each other for example until they touch or form a closed overall shape.

In a further embodiment, in step (b) the upper mold and the lower mold are moved towards each other, for example to such an extent that the distance (for example the vertical distance) between the upper mold and the blank is not less than 4 mm and/or not more than 10 mm.

In a further embodiment, a bellows is arranged between the movable connector of the lower mold and the movable guide element of the upper mold, so that a negative pressure or near vacuum or vacuum can be generated in the space enclosed by the bellows, so that pressing of the blank takes place under negative pressure or near vacuum or vacuum. Alternatively, a chamber can also be provided which encloses the lower mold, the upper mold and the blank in such a way that pressing of the blank takes place under negative pressure or near vacuum or vacuum.

In further embodiment
(f) (following step (e) or after step (e)) normal pressure is generated in the airtight space. Normal pressure in the sense of this disclosure is for example atmospheric (air) pressure. Normal pressure in the sense of this disclosure is for example the pressure or air pressure prevailing outside the seal. Subsequently or thereafter, in a further embodiment, the seal is opened or returned to its initial position.

In further embodiment
(g) (subsequently or thereafter or during step (f)) the upper mold and the lower mold are moved apart. The upper mold and the lower mold can be moved apart by moving the upper mold away from the lower mold and/or moving the lower mold away from the upper mold. Subsequently or thereafter, in further embodiment, the optical element is removed. Subsequently or thereafter, in a further embodiment, the optical element is cooled according to a predetermined cooling regime (see below).

In a further embodiment, a predetermined waiting time is waited before pressing the optical (lens) element (or between step (d) and step (e)). In further embodiment, the predetermined waiting time is not more than 3 s (minus the duration of step (d)). In a further embodiment, the predetermined waiting time is not less than 1 s (minus the duration of step (d)).

The transport element or the corresponding support surface of the transport element is for example annular but for example not circular. In an embodiment, the corresponding supporting surface encloses a recess with a passage surface, which is for example the surface which forms the recess when the transport element is viewed from above. The geometric shape of the passage surface corresponds for example approximately or substantially to the geometric shape of the base area. In one embodiment, the passage surface is formed polygonal or polygonal, but for example with rounded corners. In a further embodiment, the base area is formed triangular or triangular, but for example with rounded corners. In a further embodiment, the base area is formed rectangular or rectangular, but for example with rounded corners. In a further embodiment, the base area is square, but for example with rounded corners. In a further embodiment, the base area is oval.

Glass within the meaning of this disclosure is, for example, inorganic glass. Glass within the meaning of this disclosure is, for example, silicate glass. Glass within the meaning of this disclosure is for example glass as described in WO 2009/109209 A1. Glass within the meaning of this disclosure comprises for example
0.2 to 2 wt.-% Al₂ O₃,
0.1 to 1 wt.-% Li₂ O,
0.3, especially 0.4, to 1.5 wt.-% Sb₂ O₃,
60 to 75 wt.-% SiO₂,
3 to 12 wt.-% Na₂ O,
3 to 12 wt.-% K₂ O and
3 to 12 wt.-% CaO,
such as DOCTAN®.

In addition to requirements for special contour fidelity and precise optical properties, there may be a desire to press headlight lenses from borosilicate glass or glass systems similar to borosilicate glass in order to achieve increased weather resistance or hydrolytic resistance (chemical resistance). Standards or assessment methods regarding hydrolytic resistance (chemical resistance) are for example Hella Normtest N67057 and climatic test/humidity frost test. High hydrolytic resistance is also classified as Type 1, for example. In the light of the requirement for borosilicate glass headlight lenses with corresponding hydrolytic resistance, there may be a desire to press headlight lenses from borosilicate glass or similar glass systems with the same hydrolytic resistance (chemical resistance). In departure from this desire, the present disclosure relates to an alternative process for the manufacture of an optical element or of a headlight lens, wherein a blank of non-borosilicate glass and/or of cold sodium silicate glass (cold sodium silicate glass) is heated and/or provided and after heating and/or after providing between a lower mold, for example for molding and/or for press-molding of a first optically effective surface of the optical element, and at least one upper mold, for example for molding and/or for press-molding a second optically effective surface of the optical element, is press-molded to the optical element, for example on both sides, wherein the first optically effective surface and/or the second optically effective surface (after the pressing) is sprayed with a surface treatment agent. Spraying and/or spraying in the sense of the present disclosure comprises for example fogging, misting and/or (the use of) spray mist. Spraying and/or spraying-to within the meaning of the present disclosure for example means nebulizing, fogging and/or (the use of) spray mist.

Soda lime glass within the meaning of this disclosure comprises for example
60 to 75 wt.-% SiO₂ and
3 to 12 wt.-% CaO,
or
70 to 75 wt.-% SiO₂ and
3 to 12 wt.-% CaO.

Soda lime glass within the meaning of this disclosure comprises for example
60 to 75 wt.-% SiO₂,
3 to 12 wt.-% K₂O and
3 to 12 wt.-% CaO,
or
70 to 75 wt.-% SiO₂,
3 to 12 wt.-% K₂O and
3 to 12 wt.-% CaO.

Soda lime glass within the meaning of this disclosure comprises for example
60 to 75 wt.-% SiO₂,
3 to 12 wt.-% Na₂ O,
3 to 12 wt.-% K₂ O and
3 to 12 wt.-% CaO,
or
70 to 75 wt.-% SiO₂,
3 to 12 wt.-% Na₂ O,
3 to 12 wt.-% K₂ O and
3 to 12 wt.-% CaO.

Soda lime glass within the meaning of this disclosure comprises for example
0.2 to 2 wt.-% Al₂ O₃,
60 to 75 wt.-% SiO₂,
3 to 12 wt.-% Na₂ O,
3 to 12 wt.-% K₂O and
3 to 12 wt.-% CaO,

Soda lime glass within the meaning of this disclosure comprises for example
0.2 to 2 wt.-% Al₂ O₃,
0.1 to 1 wt.-% Li₂ O,
60 to 75 wt.-% SiO₂,
3 to 12 wt.-% Na₂ O,
3 to 12 wt.-% K₂O and
3 to 12 wt.-% CaO,
or
0.2 to 2 wt.-% Al₂ O₃,
0.1 to 1 wt.-% Li₂ O,
70 to 75 wt.-% SiO₂,
3 to 12 wt.-% Na₂ O,
3 to 12 wt.-% K₂O and
3 to 12 wt.-% CaO,

Soda lime glass within the meaning of this disclosure comprises for example
0.2 to 2 wt.-% Al₂ O₃,
0.1 to 1 wt.-% Li₂ O,
0.3, especially 0.4, to 1.5 wt.-% Sb₂ O₃,
60 to 75 wt.-% SiO₂,
3 to 12 wt.-% Na₂ O,
3 to 12 wt.-% K₂ O and
3 to 12 wt.-% CaO,
such as DOCTAN®, or
0.2 to 2 wt.-% Al₂ O₃,
0.1 to 1 wt.-% Li₂ O,
0.3, especially 0.4, to 1.5 wt.-% Sb₂ O₃,
70 to 75 wt.-% SiO₂,
3 to 12 wt.-% Na₂ O,
3 to 12 wt.-% K₂ O and
3 to 12 wt.-% CaO.

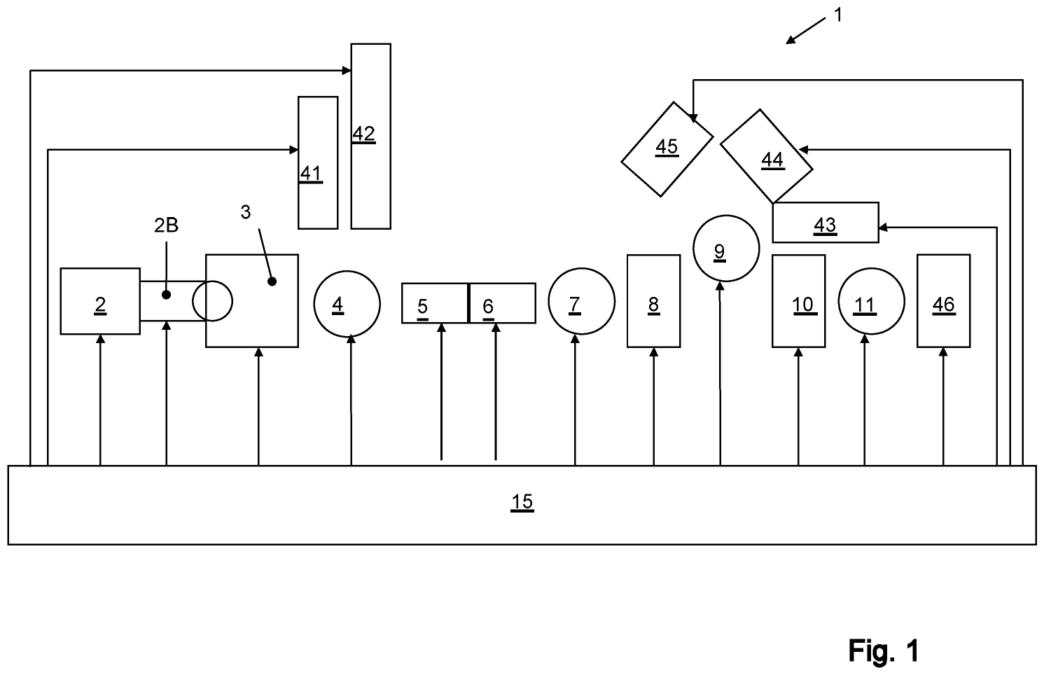

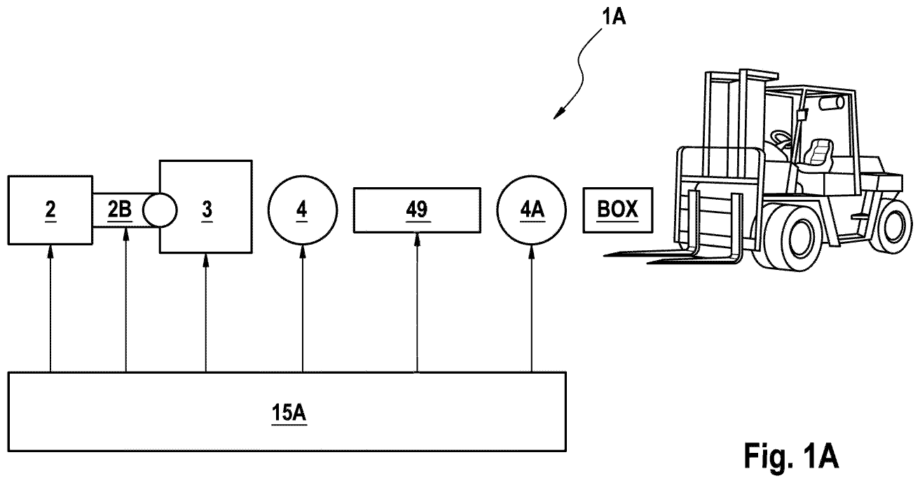

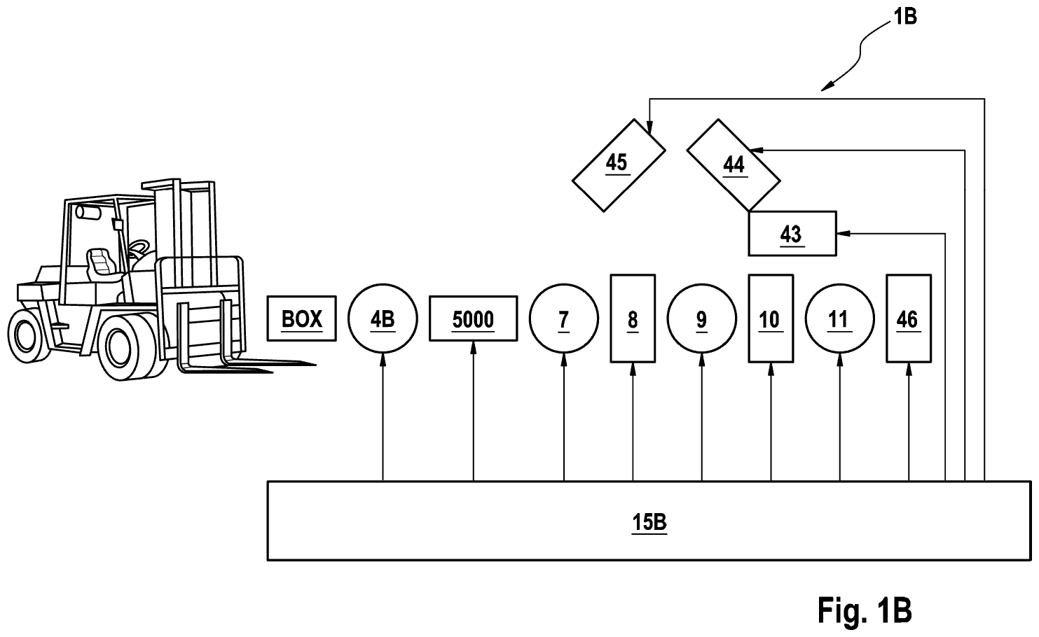

The surface treatment agent comprises for example AlCl₃*6H₂ O (dissolved in solvent and/or H₂O), suitable mixing ratios being taken from DE 103 19 708 A1 (e.g. FIG. 1). For example, at least 0.5 g, for example at least 1 g AlCl₃*6H₂ O per liter H₂ O are provided.

In a further embodiment, the first optically effective surface and the second optically effective surface are sprayed at least partially simultaneously (overlapping in time) with the surface treatment agent.

In a further embodiment, the temperature of the optical element and/or the temperature of the first optically effective surface and/or the temperature of the second optically effective surface when sprayed with surface treatment agent is not less than T_{G} or T_{G}+20K, where T_{G} denotes the glass transition temperature.

In a further embodiment, the temperature of the optical element and/or the temperature of the first optically effective surface and/or the temperature of the second optically effective surface when sprayed with surface treatment agent is no greater than T_{G}+100K.

In a further embodiment, the surface treatment agent is sprayed onto the optically effective surface as a spray agent, wherein the surface treatment agent forms droplets whose size and/or whose average size and/or whose diameter and/or whose average diameter is not greater than 50 μm.

In a further embodiment, the surface treatment agent is sprayed onto the optically effective surface as a spray agent, wherein the surface treatment agent forms droplets whose size and/or whose average size and/or whose diameter and/or whose average diameter is not smaller than 10 μm.

In a further embodiment, the surface treatment agent is sprayed mixed with compressed air. In a further embodiment, compressed air is used to generate a spray mist for the surface treatment agent, for example in conjunction with a mixing nozzle or a two-substance nozzle.

In a further embodiment, spraying of the optically effective surface with the surface treatment agent is performed prior to cooling of the optical element in a cooling path for cooling in accordance with a cooling regime.

In a further embodiment, an optically effective surface is sprayed with the surface treatment agent for no longer than 4 seconds. For example, an optically effective surface is sprayed with the surface treatment agent for no longer than 12 seconds, for example no longer than 8 seconds, for example no shorter than 2 seconds. For example, spraying is continued until the optically effective surface is sprayed with not less than 0.05 ml of surface treatment agent and/or with not more than 0.5 ml, for example 0.2 ml of surface treatment agent.

It is provided for example that the headlight lens at the surface after spraying with the surface treatment agent consists of at least 90%, for example at least 95%, for example (essentially) 100% quartz glass. For example, it is provided that the following is applicable in relation to the oxygen bonding to silicon on the surface of the headlight lens or optical element

$$\frac{Q ( 4 )}{Q ( 4 ) + Q ( 3 )} \geq 0 , 9$$

for example

$$\frac{Q ( 4 )}{Q ( 4 ) + Q ( 3 )} \geq 0 , 95$$

In the above Q(3) and Q(4) denote the crosslinking of the oxygen ions with the silicon ion, wherein 3 oxygen ions (Q(3)) or 4 oxygen ions (Q(4)) are arranged at the tetrahedron corners of the silicon ion. The proportion of quartz glass decreases towards the interior of the headlight lens or optical element, wherein, at a depth (distance from the surface) of 5 μm, it is for example provided that the proportion of quartz glass is at least 10%, for example at least 5%. It is for example provided that the following is applicable in relation to the oxygen bonding to silicon of the headlight lens or the optical element at a depth of 5 μm

$$\frac{Q ( 4 )}{Q ( 4 ) + Q ( 3 )} \geq 0 , 1$$

for example

$$\frac{Q ( 4 )}{Q ( 4 ) + Q ( 3 )} \geq 0 , 05$$

It is for example provided that the proportion of quartz glass at a depth (distance from the surface) of 5 μm is not greater than 50%, for example not greater than 25%. It is for example provided that the following is applicable in relation to the oxygen bonding to silicon of the headlight lens or optical element at a depth of 5 μm

$$\frac{Q ( 4 )}{Q ( 4 ) + Q ( 3 )} \leq 0 , 5$$

for example

$$\frac{Q ( 4 )}{Q ( 4 ) + Q ( 3 )} \leq 0 , 25$$

An optical element in the sense of this disclosure is for example a lens, for example a headlight lens or a lens-like freeform. An optical element within the meaning of the present disclosure is, for example, a lens or a lens-like freeform having, for example, a circumferential, interrupted or interrupted circumferential bearing edge. An optical element within the meaning of the present disclosure may be, for example, an optical element as described, e.g. in WO 2017/059945 A1, WO 2014/114309 A1, WO 2014/114308 A1, WO 2014/114307 A1, WO 2014/072003 A1, WO 2013/178311 A1, WO 2013/170923 A1, WO 2013/159847 A1, WO 2013/123954 A1, WO 2013/135259 A1, WO 2013/068063 A1, WO 2013/068053 A1, WO 2012/130352 A1, WO 2012/072187 A2, WO 2012/072188 A1, WO 2012/072189 A2, WO 2012/072190 A2, WO 2012/072191 A2, WO 2012/072192 A1, WO 2012/072193 A2, PCT/EP2017/000444 is described. Each of these writings is incorporated by reference in its entirety. The claimed method is for example applied to non-symmetrical headlight lenses or to non-rotationally symmetrical headlight lenses. For example, the claimed method is e.g. applied to headlight lenses with non-symmetrical contours or to non-rotationally symmetrical contours. For example, the claimed method is e.g. applied to headlight lenses with deterministic surface structures, such as WO 2015/031925 A1 disclosed, and for example with deterministic non-periodic surface structures, such as DE 10 2011 114 636 A1 disclosed.

In a further embodiment, the optical element is placed on a transport element after press-molding, sprayed with surface treatment agent on the transport element, and then or subsequently passes through a or the cooling path with the transport element without touching an optical surface of the optical element (see above). Adherence to such a cooling regime is necessary to prevent internal stresses within the optical element or headlight lens, which, although not visible during a visual inspection, can in some cases significantly impair the photometric properties as an optical element of a headlight lens. These impairments can cause a corresponding optical element or headlight lens to become unusable. Surprisingly, it has been found that spraying the hot optical element or the hot headlight lens after press-molding or after demolding following press-molding alters the cooling regime, but any resulting optical stresses are negligible. Also surprising is the fact that a corresponding headlight lens is within the optical tolerances specified above in terms of its optical properties, even though the refractive index is reduced due to the quartz glass content on the surface.

In a further embodiment, the transport element is made of steel. For clarification, the transport element is not part of the optical element (or headlight lens), or the optical element (or headlight lens) and the transport element are not part of a common one-piece body.

In a further embodiment, the transport element is heated, for example inductively, before the optical element is picked up. In a further embodiment, the transport element is heated at a heating rate of at least 20 K/s, for example at least 30 K/s. In a further embodiment, the transport element is heated at a heating rate of no more than 50 K/s. In a further embodiment, the transport element is heated by means of a current-carrying winding/coil arranged above the transport element.

In a further embodiment, the optical element comprises a support surface that lies outside the intended light path for the optical element, wherein the support surface, for example only the support surface, is in contact with a corresponding support surface of the transport element when the optical element is placed on the transport element. In a further embodiment, the support surface of the optical element is located at the edge of the optical element. In a further embodiment, the transport element comprises at least one limiting surface for aligning the optical element on the transport element or for limiting or preventing movement of the optical element on the transport element. In one embodiment, the limiting surface or a limiting surface is provided above the corresponding support surface of the transport element. In a further embodiment, (at least) two boundary surfaces are provided, whereby it can be provided that one boundary surface lies below the corresponding support surface of the transport element and one boundary surface lies above the corresponding support surface of the transport element. In a further embodiment, the transport element is adapted, manufactured, for example milled, to the optical element or to the support surface of the optical element.

The transport element or the contact surface of the transport element is for example annular but for example not circular.

In further embodiment, the preform is made from molten glass, cast and/or molded. In a further embodiment, the mass of the preform is 10 g to 400 g, for example 20 g to 250 g.

In a further embodiment, the temperature gradient of the preform is adjusted such that the temperature of the core of the preform is above 10K+T·G

In a further embodiment, the preform is first cooled to reverse its temperature gradient, for example with the addition of heat, and then heated, it being e.g. provided that the preform is heated in such a way that the temperature of the surface of the preform after heating is at least 100 K, for example at least 150 K, higher than the transformation temperature T_{G} of the glass. The transformation temperature T_{G} of the glass is the temperature at which the glass becomes hard. For the purposes of the present disclosure, the transformation temperature T_{G} of the glass is for example intended to be the temperature of the glass at which the latter has a viscosity log in a range around 13.2 (corresponding to 10^{13.2} Pas), for example between 13 (corresponding to 10¹³ Pas) and 14.5 (corresponding to 10^{14.5} Pas). With respect to glass grade B270, the transformation temperature T_{G} is approximately 530° C.

In a further embodiment, the temperature gradient of the preform is set such that the temperature of the upper surface of the preform is at least 30K, for example at least 50K, above the temperature of the lower surface of the preform. In further embodiment, the temperature gradient of the preform is adjusted such that the temperature of the core of the preform is at least 50K below the temperature of the surface of the preform. In further embodiment, the preform is cooled such that the temperature of the preform before heating is T_{G}−80K to T_{G}+30K. In further embodiment, the temperature gradient of the preform is adjusted such that the temperature of the core of the preform is 450° C. to 550° C. For example, the temperature gradient is adjusted such that the temperature of the core of the preform is below T_{G} or close to T_{G}. In a further embodiment, the temperature gradient of the preform is adjusted such that the temperature of the surface of the preform is 700° C. to 900° C., for example 750° C. to 850° C. In a further embodiment, the preform is heated such that its surface (for example immediately before pressing) assumes a temperature corresponding to the temperature at which the glass of the preform has a viscosity log between 5 (corresponding to 10⁵ Pas) and 8 (corresponding to 10⁸ Pas), for example a viscosity log between 5.5 (corresponding to 10^{5.5} Pas) and 7 (corresponding to 10⁷ Pas).

For example, it is provided that the preform is removed from a mold for forming or producing the preform before the temperature gradient is reversed. For example, it is intended that the reversal of the temperature gradient takes place outside of a mold. For the purposes of this disclosure, cooling with the addition of heat is intended to mean, for example, that cooling is carried out at a temperature of more than 100° C.

The disclosure concerns also a device for carrying out the aforementioned processes.

For the purposes of this disclosure, press-molding means for example that a (for example optically effective) surface is pressed in such a way that subsequent finishing of the contour of this (for example optically effective) surface can be omitted or is omitted or is not provided for. It is thus for example intended that a press-molded surface is not ground after the press-molding. Polishing, which does not affect the contour of the surface but the surface quality, may be provided. By press-molding on both sides it is to be understood for example that a (for example optically effective) light exit surface is press-molded and a (for example optically effective) light entrance surface for example opposite the (for example optically effective) light exit surface is also press-molded.

Press-molding in the sense of this disclosure refers solely to (optically effective) surfaces or surfaces that serve the purposeful influencing of light. Press-molding within the meaning of this disclosure thus does not refer to the pressing of surfaces or surfaces which do not serve the purposeful and/or intended alignment of light passing through them. I.e., for the use of the expression press-molding in the sense of the claims, it is irrelevant whether the surfaces and areas that do not serve an optical influence or the influencing of light according to the intended use are post-processed or not.

In one embodiment, the blank is placed on an annular support surface of a supporting body with a hollow cross section and is heated on the supporting body, for example in such a way that a temperature gradient is established in the blank in such a way that the blank is cooler on the inside than on its outer region, the supporting surface being cooled by means of a cooling medium flowing through the supporting body, wherein the blank of glass is press-molded after heating to the optical element, for example on both sides, wherein the supporting body comprises at least two flow channels for the cooling medium flowing through, each extending only over a portion of the annular support surface, and wherein two flow channels are connected with metallic filler material, for example solder, in a region in which they leave the supporting surface.

A guide rod as defined in the present disclosure may be a rod, tube, profile, or the like.

Fixed in the sense of this disclosure means for example directly or indirectly fixed to a foundation of the press station or the press or a foundation on which the press station or the press stands. Two elements in the sense of this disclosure are fixed to each other for example if for pressing it is not intended that they are moved relative to each other.

For pressing, the lower mold and the upper mold are for example moved towards each other in such a way that they form a closed mold or cavity or a substantially closed mold or cavity. Moving towards each other in the sense of the present disclosure means for example that both molds, i.e. both the lower mold and the upper mold, are moved. However, it can also mean that only one of the two molds is moved, i.e., either the lower mold or the upper mold.

A recess in the sense of the disclosure comprises for example a bearing which couples or connects the recess with the corresponding guide rod. A recess in the sense of the present disclosure can be extended to a sleeve or be designed as a sleeve. A recess in the sense of the present disclosure can be extended to a sleeve with an inner bearing or can be designed as a sleeve with an inner bearing.

In a matrix headlight, the optical element or a corresponding headlight lens is used, for example, as an attachment optics and/or as a secondary lens for imaging one or the attachment optics. An attachment optics in the sense of the present disclosure is arranged for example between the secondary optics and a light source arrangement. An attachment optics within the meaning of this disclosure is for example disposed in the light path between the secondary optics and the light source arrangement. An attachment optic within the meaning of the present disclosure is, for example, an optical component for shaping a light distribution as a function of light generated by the light source arrangement and irradiated by the latter into the attachment optic. In this context, the generation or shaping of a light distribution is performed, for example, by TIR, i.e., by total reflection.

The optical element or a corresponding lens is also used in a projection headlight, for example. In the design as a headlight lens for a projection headlight, the optical element or a corresponding headlight lens reproduces the edge of a shield as bright-dark-boundary on the road.

The disclosure concerns further a method of manufacturing a vehicle headlight, wherein an optical element manufactured according to a method having one or more of the aforementioned features is installed in a headlight housing.

The disclosure concerns further a method for manufacturing a vehicle headlight, wherein an optical element manufactured according to a method having one or more of the aforementioned features is placed in a headlight housing and assembled together with at least one light source or a plurality of light sources to form a vehicle headlight.

The disclosure concerns also a method for manufacturing a vehicle headlight, wherein an optical element (in a headlight housing) produced by a method having one or more of the aforementioned features is installed together with at least one light source and a shield to form a vehicle headlight in such a way that an edge of the shield can be imaged as a bright-dark-boundary (HDG) by the (automotive) lens element by means of light emitted by the light source.

The disclosure concerns also a method for manufacturing a vehicle headlight, wherein an optical element produced by a method having one or more of the above-mentioned features is placed in a headlight housing as a secondary optics or as part of a secondary optics comprising a plurality of lenses for imaging a light output surface of an attachment optics and/or an illumination pattern generated by means of a primary optics and is assembled together with at least one light source or a plurality of light sources and the attachment optics to form a vehicle headlight.

The disclosure concerns further a method of manufacturing a vehicle headlight, wherein a primary optics or an attachment optics array is manufactured as a primary optics for generating the illumination pattern in accordance with a method having one or more of the foregoing features.

The disclosure concerns further a method for manufacturing a vehicle headlight, wherein the primary optics comprises a system of movable micromirrors, for example a system of more than 100,000 movable micromirrors, for example a system of more than 1,000,000 movable micromirrors, for generating the illumination pattern

Further methods relate to a method for manufacturing an objective, wherein at least a first lens is produced according to a method having one or more of the aforementioned features and is subsequently installed in an objective and/or an objective housing. In a further embodiment, at least a second lens is produced according to a method having one or more of the aforementioned features and is subsequently installed in an objective and/or an objective housing. In a further embodiment, at least a third lens is produced according to a method having one or more of the aforementioned features and is subsequently incorporated into an objective and/or an objective housing. In a further embodiment, at least a fourth lens is produced by a method having one or more of the aforementioned features and is subsequently incorporated into an objective and/or an objective housing.

Further methods relate to a method for producing a camera, wherein an objective produced according to a method with one or more of the aforementioned features is installed together with a sensor or light-sensitive sensor in such a way that an object can be imaged onto the sensor by means of the objective. The above-mentioned objective and/or camera can be used as sensoric or environmental sensoric system for use in vehicle headlights, such as the above-mentioned vehicle headlights, and/or in driving assistance systems.

Further methods relate to a method for manufacturing a microprojector or a microlens array, wherein the microlens array is produced according to a method having one or more of the aforementioned features. For manufacturing a projection display, the microlens array comprising a plurality of microlenses and/or projection lenses arranged on a carrier or substrate is assembled together with object structures and a light source, for example for illuminating the object structures. The method is used for microlens arrays with a plurality of microlenses and/or projection lenses on a planar base surface, but for example also on a curved base surface. For example, it is provided that the object structures (on a side of the carrier or substrate facing away from the microlenses and/or projection lenses) are arranged on the carrier or substrate.

It may be provided that the microlens array is pressed in accordance with a method having one or more of the foregoing features, and that the microlenses are not left in their entirety on the carrier or substrate but that the microlenses or projection lenses are singulated.

Microlenses in the sense of the present disclosure may be lenses with a diameter of not more than 1 cm. However, microlenses within the meaning of the present disclosure may be, for example, lenses having a diameter of not more than 1 mm. Microlenses within the meaning of the present disclosure may be lenses having a diameter of not less than 0.1 mm.

In a further embodiment, it is provided that the maximum deviation of the actual value from the target value of the distance between two optically effective surfaces of the optical element is not greater than 40 μm, for example not greater than 30 μm, for example not greater than 20 μm, for example not less than 2 μm. In a further embodiment, it is provided that the maximum deviation of the actual value from the target value of the distance between an optically effective surface and a plane orthogonal to the optical axis of the optically effective surface, this plane comprising the geometric center of gravity of the optical element, is not greater than 20 μm, for example not greater than 15 μm, for example not greater than 8 μm, for example not less than 1 μm. In a further embodiment, it is provided that the value RMSt (total surface shape deviation) according to DIN ISO 10110-5 of April 2016 for the optically effective surfaces of the optical element, for at least one optically effective surface of the optical element and/or for at least two optically effective surfaces of the optical element, is not greater than 12 μm, for example is not greater than 10 μm, for example is not greater than 8 μm, for example is not greater than 6 μm, for example is not greater than 4 μm, for example is not greater than 2 μm, for example is not less than 0.5 μm.

Motor vehicle in the sense of this disclosure is for example a land vehicle which can be used individually in road traffic. Motor vehicles within the meaning of this disclosure are for example not limited to land vehicles with internal combustion engine.

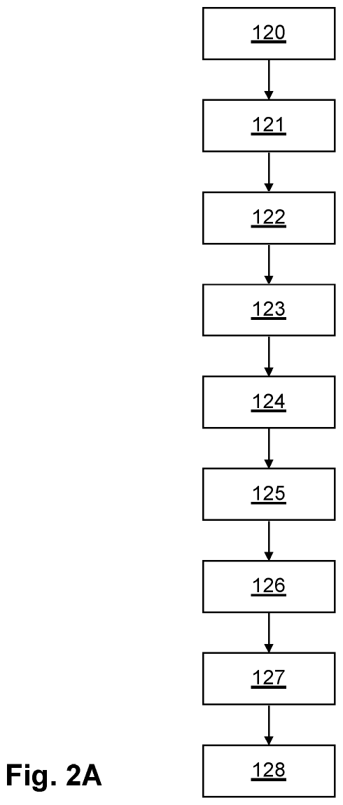

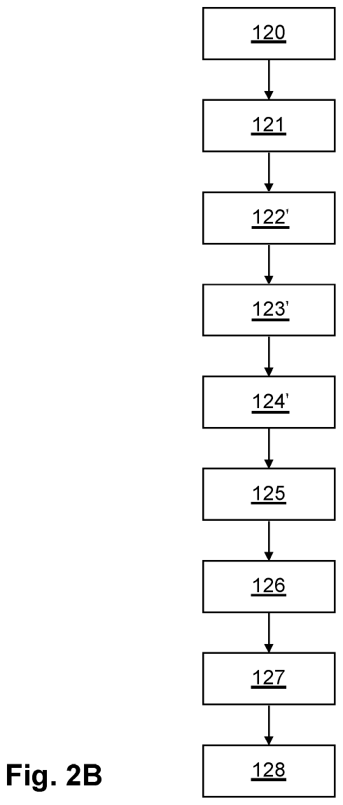

FIG. 1 as well as FIG. 1A and FIG. 1B show a device 1 or 1A and 1B—shown in a schematic diagram—for carrying out a process shown in FIG. 2A or FIG. 2B for producing optical elements such as optical lenses, such as motor vehicle headlight lenses, e.g., such as the (motor vehicle) headlight lens 202 shown in FIG. 34—in a schematic diagram—or (lens-like) freeforms, for example for motor vehicle headlights, for example the use thereof as described below with reference to FIG. 45.

FIG. 34 shows a schematic diagram of a motor vehicle headlight 201 (projection headlight) of a motor vehicle 20, comprising a light source 210 for generating light, a reflector 212 for reflecting light that can be generated by means of the light source 210, and a shield 214. The motor vehicle headlight 201 further comprises a headlight lens 202 for imaging an edge 215 of the shield 214 as a bright-dark boundary 220 for light that can be generated by means of the light source 210. Typical requirements placed on the bright-dark boundary or on the light distribution taking into account or incorporating the bright-dark boundary are disclosed, for example, in Bosch—Automotive Handbook, 9^{th} edition, ISBN 978-1-119-03294-6, page 1040. A headlight lens within the meaning of this disclosure is, for example, a headlight lens by means of which a bright-dark boundary can be generated, and/or a headlight lens by means of which the requirements according to Bosch—Automotive Handbook, 9^{th} edition, ISBN 978-1-119-03294-6 (incorporated by reference in its entirety), page 1040 can be met. The headlight lens 202 comprises a lens body 203 made of glass, which comprises a substantially planar (for example optically effective) surface 205 facing the light source 210 and a substantially convex (for example optically effective) surface 204 facing away from the light source 210. The headlight lens 202 further comprises a (for example circumferential) edge 206, by means of which the headlight lens 202 can be fixed in the motor vehicle headlight 201. The elements in FIG. 34 are drawn with simplicity and clarity in mind, and not necessarily to scale. For example, the scales of some elements are exaggerated relative to other elements to enhance understanding of the embodiment.

FIG. 35 shows the headlight lens 202 from below. FIG. 36 shows a cross-section through an embodiment of the headlight lens 202. FIG. 37 shows a section of the headlight lens 202 marked by a dash-dotted circle in FIG. 36. The planar (for example optically effective) surface 205 projects in the form of a step 260 in the direction of the optical axis 230 of the headlight lens 202 beyond the lens edge 206 or beyond the surface 261 of the lens edge 206 facing the light source 210, the height h of the step 260 being, for example, not more than 1 mm, for example not more than 0.5 mm. For example, the nominal value of the height h of the step 260 is 0.2 mm.

The thickness r of the lens edge 206 according to FIG. 36 is at least 2 mm but not more than 5 mm. According to FIG. 35 and FIG. 36, the diameter DL of the headlight lens 202 is at least 40 mm but not more than 100 mm. The diameter DB of the substantially planar (for example optically effective) surface 205 is equal to the diameter DA of the convexly curved optically effective surface 204. In an embodiment, the diameter DB of the substantially planar optically effective surface 205 is not more than 110% of the diameter DA of the convexly curved optically effective surface 204. Moreover, the diameter DB of the substantially planar optically effective surface 205 is for example at least 90% of the diameter DA of the convexly curved optically effective surface 204. For example, the diameter DL of the headlight lens 202 is about 5 mm larger than the diameter DB of the substantially planar optically effective surface 205 or the diameter DA of the convexly curved optically effective surface 204. The diameter DLq of the headlight lens 202 orthogonal to DL is at least 40 mm but not more than 80 mm and is smaller than the diameter DL. For example, the diameter DLq of the headlight lens 202 is about 5 mm larger than the diameter DBq orthogonal to DB.

In a further embodiment, the (optically effective) surface 204 intended to face away from the light source and/or the (optically effective) surface 205 intended to face the light source has/have a light-scattering surface structure (produced/pressed by molding). A suitable light-scattering surface structure comprises, for example, a modulation and/or a (surface) roughness of at least 0.05 μm, for example at least 0.08μ or is designed as a modulation optionally with an additional (surface) roughness of at least 0.05 μm, for example at least 0.08μ. Roughness in the sense of the present disclosure shall be defined for example as Ra, for example according to ISO 4287. In a further embodiment, the light scattering surface structure may have a structure that simulates the surface of a golf ball or may be configured as a structure mimicking a golf ball surface. Suitable light scattering surface structures are disclosed, for example, in DE 10 2005 009 556 A1, DE 102 26 471 B4 and DE 299 14 114 U1. Further embodiments of light scattering surface structures are disclosed in German patent specification 1 099 964, DE 36 02 262 C2, DE 40 31 352 A1, U.S. Pat. No. 6,130,777, US 2001/0033726 A1, JP 10123307 A, JP 09159810 A, DE 11 2018 000 084 A5, and JP 01147403 A.

FIG. 39 shows an adaptive headlight or vehicle headlight F20 for situation-dependent or traffic-dependent illumination of the surroundings or the roadway in front of the motor vehicle 20 as a function of environmental sensoric F2 of the motor vehicle 20. For this purpose, the vehicle headlight F20 shown schematically in FIG. 39 has an illumination device F4 which is activated by means of a controller F3 of the vehicle headlight F20. Light L4 generated by the illumination device F4 is emitted from the vehicle headlight F20 as an illumination pattern L5 by means of an objective F5, which may comprise one or more optical lens elements or headlight lenses. Examples of corresponding illumination patterns are shown in FIG. 40 and FIG. 41, as well as the websites web.archive.org/web/20150109234745/http://www.audi.de/content/de/brand/de/vorsprung_durch_technik/content/2013/08/Audi-A8-erstrahlt-in-neuem-Licht.html (accessed Sep. 5, 2019) and www.all-electronics.de/matrix-led-und-laserlicht-bietet-viele-vorteile/(accessed Sep. 2, 2019). In the embodiment according to FIG. 41, the illumination pattern L5 includes dazzled areas L51, dimmed areas L52, and cornering light L53.

FIG. 42 shows an embodiment example for the illumination device F4, wherein it comprises a light source arrangement F41 with a plurality of individually adjustable areas or pixels. For example, up to 100 pixels, up to 1000 pixels, or not less than 1000 pixels may be provided, which in the sense are individually controllable by means of the controller F3 such that they can be individually switched on or off, for example. It may be provided that the illumination device F4 further comprises an attachment optics F42 for generating an illumination pattern (such as L4) at the light emitting surface F421 in dependence with the correspondingly controlled areas or pixels of the light source arrangement F41 or in accordance with the light L41 irradiated into the attachment optics F42.

Matrix headlights within the meaning of the present disclosure may also be matrix SSL HD headlights. Examples of such headlights are shown in the Internet link www.springerprofessional.de/fahrzeug-lichttechnik/fahrzeugsicherheit/hella-bringt-neues-ssl-hd-matrix-lichtsystem-auf-den-markt/17182758 (accessed May 28, 2020), the Internet link www.highlight-web.de/5874/hella-ssl-hd/ (accessed May 28, 2020), and the Internet link www.hella.com/techworld/de/Lounge/Unser-Digital-Light-SSL-HD-Lichtsystem-ein-neuerMeilenstein-der-automobilen-Lichttechnik-55548/ (accessed May 28, 2020).

FIG. 43 shows a one-piece attachment optics array V1 in a side view. FIG. 44 shows the attachment optics array V1 in a top view from behind. The attachment optics array V1 comprises a base part V20 on which lenses V2011, V2012, V2013, V2014, and V2015 attached thereto and an attachment optics V11 having a light entrance area V111, an attachment optics V12 having a light entrance area V121, an attachment optics V13 having a light entrance area V131, an attachment optics V14 having a light entrance area V141, and an attachment optics V15 having a light entrance area V151 are formed. The side surfaces V115, V125, V135, V145, V155 of the attachment optics V11, V12, V13, V14, V15 are press-molded and designed in such a way that light which enters the respective light entrance area V111, V121, V131, V141 or V151 by means of a light source, is subject to total internal reflection (TIR), so that this light emerges from the base part V20 or the surface V21 of the base part V20, which forms the common light exit surface of the attachment optics V11, V12, V13, V14 and V15. The rounding radii between the light entrance areas V111, V121, V131, V141 and V151 at the transition to the side surfaces V115, V125, V135, V145 and V 155 are, for example, 0.16 to 0.2 mm.

FIG. 45 shows a vehicle headlight V201 or motor vehicle headlight in a principle representation. The vehicle headlight V201 comprises a light source arrangement VL, for example comprising LEDs, for irradiating light into the light entrance area V111 of the attachment optics V11 or the light entrance areas V121, V131, V141 and V151 of the attachment optics V12, V13, V14 and V15, which are not shown in greater detail. In addition, the vehicle headlight V201 comprises a secondary lens V2 for imaging the light exit surface V21 of the attachment optics array V1.

Another suitable field of application for the lenses produced as described above is disclosed, for example, in DE 10 2017 105 888 A1 or the headlight described with reference to FIG. 46. Thereby, FIG. 46 exemplarily shows a light module (headlight) M20 comprising a light emitting unit M4 having a plurality of point-shaped light sources arranged in a matrix-like manner, each emitting light ML4 (having a Lambertian radiation characteristic), and further comprising a concave lens M5 and a projection lens M6. In the example shown in DE 10 2017 105 888 A1 according to FIG. 46, the projection optics M6 comprises two lenses arranged one behind the other in the beam path, which have been produced according to a method corresponding to the aforementioned method. The projection optics M6 reproduces the light ML4 emitted by the light emitting unit M4 and, after passing through the concave lens M5, further shaped light ML5 as a resulting light distribution ML6 of the light module M20 on a roadway in front of the motor vehicle in which the light module or the headlight is (have been) installed.

The light module M20 has a controller designated with reference sign M3, which controls the light emitting unit M4 as a function of the values of a sensor system or environmental sensoric M2. The concave lens M5 has a concavely curved exit surface on the side facing away from the light emitting unit M4. The exit surface of the concave lens M5 redirects light ML4 irradiated into the concave lens M5 by the light emitting unit M4 with a large irradiation angle toward the edge of the concave lens by means of total reflection, so that it does not pass through the projection optics M6. According to DE 10 2017 105 888 A1, light beams emitted at a ‘large beam angle’ by the light emitting unit M4 are those light beams which (without arrangement of the concave lens M5 in the beam path) would be poorly imaged, for example blurred, on the roadway by means of the projection optics M6 due to optical aberrations and/or which could lead to stray light which reduces the contrast of the image on the roadway (see also DE 10 2017 105 888 A1). It can be provided that the projection optics M6 can only sharply image light with an aperture angle limited to approximately +/−20°. Light beams with aperture angles greater than +/−20°, for example greater than +/−30°, are thus prevented from hitting the projection optics M6 by the arrangement of the concave lens M5 in the beam path.

The light emitting unit M4 can be designed differently. According to one embodiment, the individual point-shaped light sources of the light emitting unit M4 each comprise a semiconductor light source, for example a light emitting diode (LED). The LEDs can be selectively controlled individually or in groups to switch the semiconductor light sources on or off or to dim them. For example, the light module M20 has more than 1,000 individually controllable LEDs. For example, the light module M20 can be designed as a so-called μAFS (micro-structured adaptive front-lighting system) light module.

According to an alternative possibility, the light emitting unit M4 comprises a semiconductor light source and a DLP or micromirror array comprising a plurality of micromirrors that can be individually controlled and tilted, each of the micromirrors forming one of the point light sources of the light emitting unit M4. For example, the micromirror array comprises at least 1 million micromirrors that can be tilted, for example, at a frequency of up to 5,000 Hz.

Another example of a headlight system or light module (DLP system) is disclosed by the Internet link www.al-lighting.com/news/article/digital-light-millions-of-pixels-on-the-road/(accessed 4/13/2020). A schematically illustrated corresponding headlight module or vehicle headlight for generating an illumination pattern designated GL7A in FIG. 48 is shown in FIG. 47. The adaptive headlight G20 schematically illustrated in FIG. 47 for illuminating the environment or roadway in front of the motor vehicle 20 in dependence on environment sensors G2 of the motor vehicle 20 depending on the situation or traffic. Light GL5 generated by the illumination device G5 is formed into an illumination pattern GL6 by means of a system of micromirrors G6, as also shown for example in DE 10 2017 105 888 A1, which in turn radiates light GL7 suitable for adaptive illumination in front of the motor vehicle 20 or in an environment on the roadway in front of the motor vehicle 20 by means of projection optics G7. A suitable system G6 of movable micromirrors is disclosed by Internet link Internet link www.al-lighting.com/news/article/digital-light-millions-of-pixels-on-the-road/ (accessed Apr. 13, 2020).

A controller G4 is provided for controlling the system G6 with movable micromirrors. In addition, the headlight G20 comprises a controller G3 both for synchronization with the controller G4 and for controlling the lighting device G5 in response to environmental sensoric G2. Details of the controller G3 and G4 can be obtained from the Internet link www.al-lighting.com/news/article/digital-light-millions-of-pixels-on-the-road/ (accessed Apr. 13, 2020). The illumination device G5 may comprise, for example, an LED arrangement or a comparable light source arrangement, an optics such as a field lens (which, for example, has also been produced according to the described method), and a reflector.

The vehicle headlight G20 described with reference to FIG. 47 can be used for example in conjunction with other headlight modules or headlights to achieve a superimposed overall light profile or illumination pattern. This is shown by way of example in FIG. 49, where the overall lighting pattern is composed of the lighting pattern GL7A, GL7B and GL7C. For example, it can be provided that the illumination pattern GL7C is generated by means of the headlight 20 and the illumination pattern GL7B is generated by means of the headlight V201.

Sensor technology for the aforementioned headlights comprises for example a camera and an evaluation or pattern recognition system for evaluating a signal supplied by the camera. A camera comprises for example an objective or multi-lens objective and an image sensor for imaging an image generated by the objective on the image sensor. In a particularly suitable manner, an objective such as that disclosed in U.S. Pat. No. 8,212,689 B2 (incorporated by reference in its entirety) and shown by way of example in FIG. 50 is used. Such an objective is particularly suitable because of the avoidance or considerable reduction of reflected images, since by means of such an objective it is possible, for example, to avoid confusion of a reflected image of an oncoming vehicle with light with a vehicle ahead with light. A suitable objective, for example for infrared light and/or visible light, images an object in an image plane, wherein, with respect to the imaging of an object, for each point within the image circle of the objective or for at least one point within the image circle of the lens, Pdyn≥70 dB, for example Pdyn≥80 dB, for example Pdyn≥90 dB, where Pdyn as illustrated in FIG. 51 is equal to 10·log(Pmax/Pmn), where Pmax is the maximum light power of a point in the image plane for imaging a point of the object, and where Pmin is the light power of another point in the image plane for imaging the point of the object, whose light power with respect to imaging the point of the object is greater than the light power of any further point in the image plane with respect to imaging the point of the object, or where Pmin is the maximum light power of the reflected image signals of the point of the object imaged in a further point. The lenses or a part of the lenses of the objective shown in FIG. 50 can be produced according to the claimed or disclosed method, it being provided for example that the correspondingly produced lenses have a circumferential or partially circumferential edge in deviation from the representation in FIG. 50.

Another example of the use of the method described below is the production of microlens arrays, for example microlens arrays for projection displays. Such a microlens array or its use in a projection display is shown in FIG. 52. Such microlens arrays or projection displays are described, for example, in WO 2019/072324, DE 10 2009 024 894, DE 10 2011 076 083 and DE 10 2020 107 072. The microlens array according to FIG. 52 is a one-piece (from a gob) pressed glass part, which combines in one-piece the substrate or carrier P403 and the projection lenses P411, P412, P413, P414, P415. Moreover, the projection lenses P411, P412, P413, P414, P415 are arranged following a concave contour or a parabolic contour with respect to each other. Due to this arrangement, for example, the optical axis P4140 of the projection lenses such as the projection lens P414 is tilted with respect to the orthogonal P4440 of the object structure P444 (see below). On one of the sides of the carrier P403 facing away from the projection lenses P411, P412, P413, P414, P415, a metal mask P404 is arranged, this having recesses in which object structures P441, P442, P443, P444 and P445 are arranged. An illumination layer P405 is arranged above the object structures. It may also be provided that the illumination layer P405 comprises a transparent electrode, a light-emitting layer, and a reflective back electrode. Furthermore, a light source such as disclosed in U.S. Pat. No. 8,998,435 B2 may be considered as an alternative illumination means.

The device 1 according to FIG. 1 for manufacturing optical elements such as the headlight lens 202 comprises a melting unit 2, such as a tub, in which cold sodium glass, in the present embodiment DOCTAN®, is melted in a process step 120 according to FIG. 2A. The melting unit 2 may comprise, for example, an adjustable outlet 2B. From the melting unit 2, liquid glass is transferred in a process step 121 to a preform device 3 for producing a preform, such as a gob, or a near-end-shape preform (a near-end-shape preform has a contour that is similar to the contour of the motor vehicle headlight lens or lens-like freeform for motor vehicle headlights to be pressed), for example having a mass of 10 g to 400 g, for example a mass of 50 g to 250 g. This may include, for example, molds into which a defined quantity of glass is poured. By means of the preform device 3, the preform is produced in a process step 122.

The process step 122 is followed by a process step 123, in which the preform is transferred to the cooling apparatus 5 by means of a transfer station 4 and is cooled by means of the cooling apparatus 5 at a temperature between 300° C. and 500° C., for example between 350° C. and 450° C. In the present embodiment, the preform is cooled for more than 10 minutes at a temperature of 400° C., so that its temperature inside is approximately 500° C. or more, for example 600° C. or more, for example T_{G} or more.

In a subsequent process step 124, the preform is heated by means of the heating apparatus 6 at a temperature not lower than 700° C. and/or not higher than 1600° C., for example between 1000° C. and 1250° C., it being for example provided that the preform is heated in such a way that the temperature of the surface of the preform after heating is at least 100° C., for example at least 150° C., higher than T_{G} and for example is 750° C. to 900° C., for example 780° C. to 850° C. A combination of the cooling apparatus 5 with the heating apparatus 6, is an example of a temperature control unit for adjusting the temperature gradient.

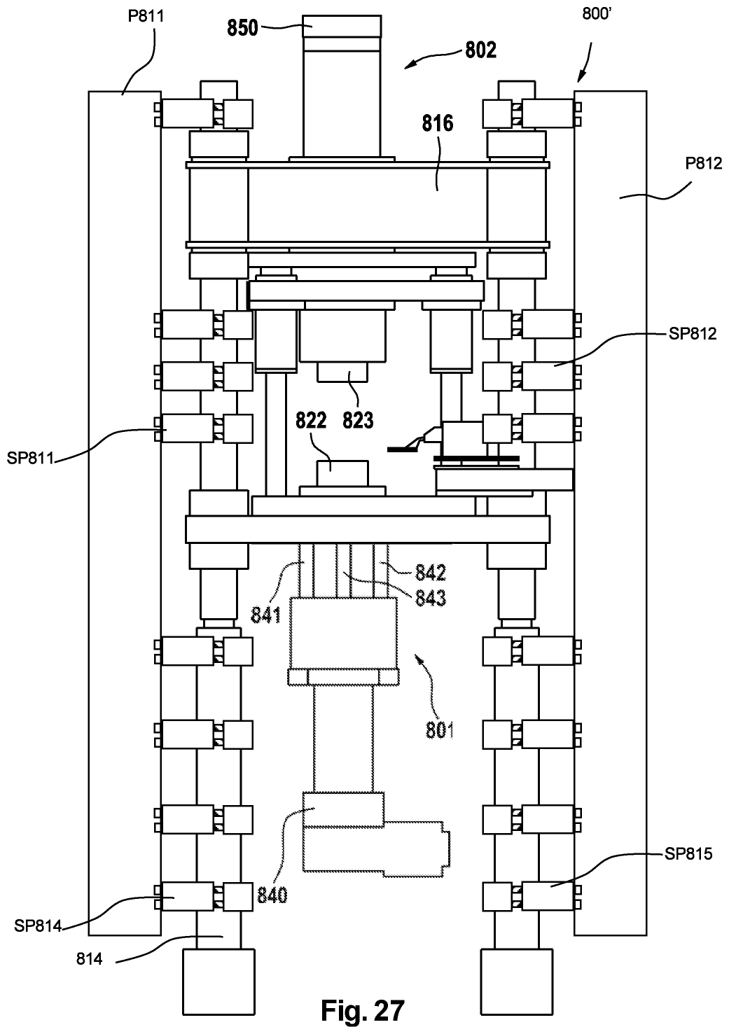

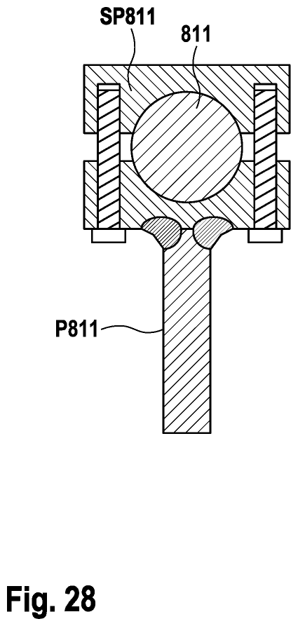

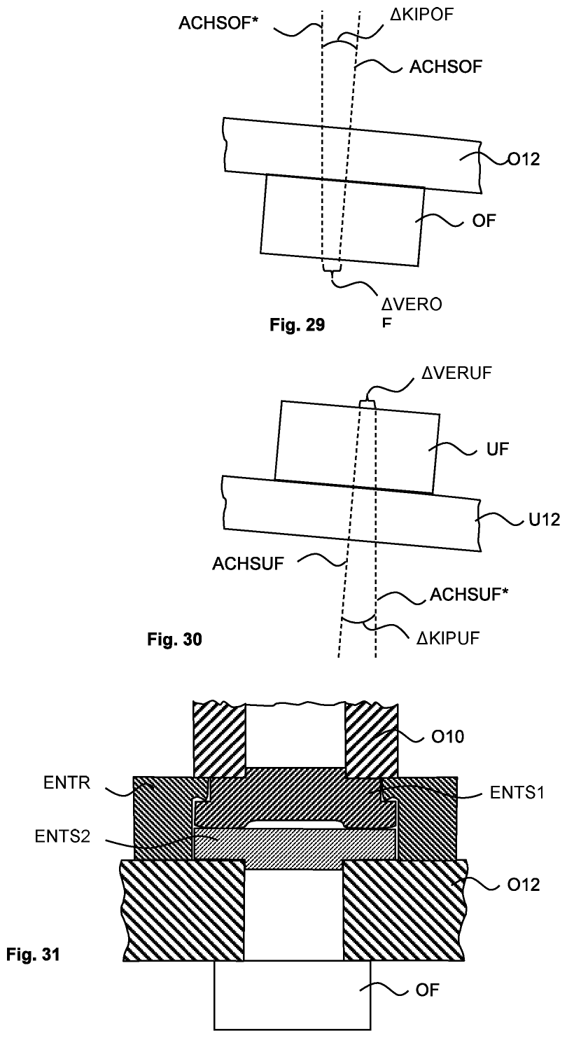

In one embodiment, this temperature control unit or the combination of cooling apparatus 5 and heating apparatus 6 is designed as a hood-type annealing furnace 5000, as shown in FIG. 14. FIG. 14 shows a preform to be heated in the form of a gob 4001 on a support device 400 in the form of a lance. Heating coils 5001 are provided for warming or heating the gob 4001. To protect these heating coils 5001 from bursting of a defective gob, the interior of the hood-type annealing furnace 5000 is lined with a protective cap 5002. FIG. 15 shows a view of the hood-type annealing furnace 5000 according to FIG. 14 from below, FIG. 16 shows a cross-section through the protective cap 5002 according to FIG. 14, FIG. 17 shows a view into the interior of the protective cap 5002 according to FIG. 14. In the embodiment according to FIG. 14, this protective cap 5002 is cup-shaped. In this case, the protective cap 5002 has a cylindrical region 5112, which merges into a covering region 5122 via a rounded region 5132. The radius of curvature of the curved region 5132 is, for example, between 5 mm and 20 mm. In the embodiment example according to FIG. 16, the radius of curvature of the curved region 5132 is approximately 10 mm. The protective cap 5002 is secured in the hood-type annealing furnace 5000 and fixed by a nut 4002. In another preferred embodiment, a bayonet lock is provided by means of which the replacement of a protective cap can be performed even more quickly.

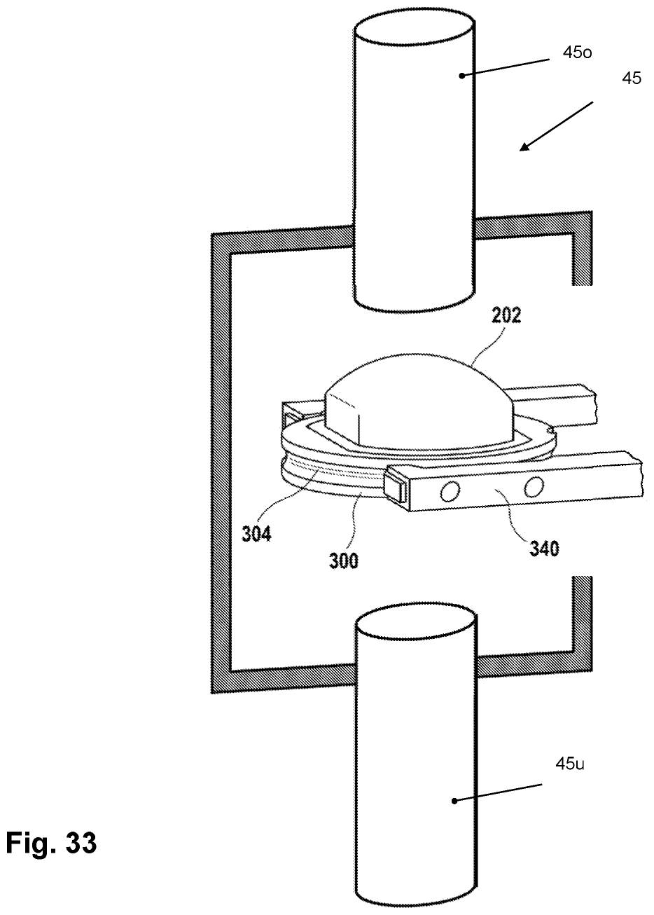

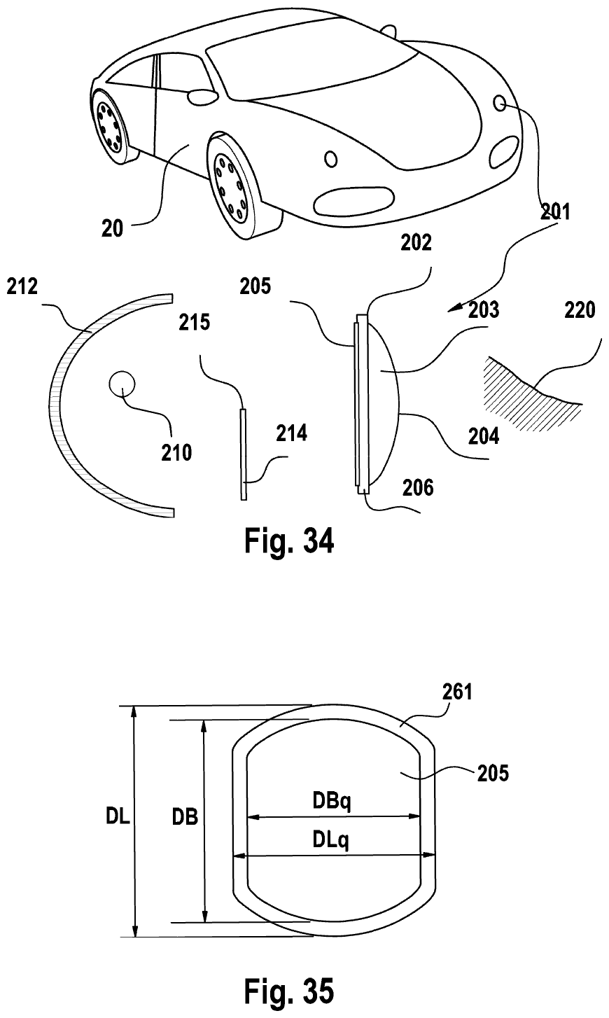

FIG. 19 shows a cross-section through an embodiment of a further protective cap 5202. FIG. 20 shows a view into the interior of the protective cap 5202 according to FIG. 19. The protective cap 5202 is also cup-shaped, but in addition to a cylindrical region 5212 also has a conical region 5242. The conical region 5242 transitions to a covering region 5222 via a curvature 5232. The conical region 5242 defines a volume that is between 30% and 50% of the volume of the cavity of the protective cap 5202.

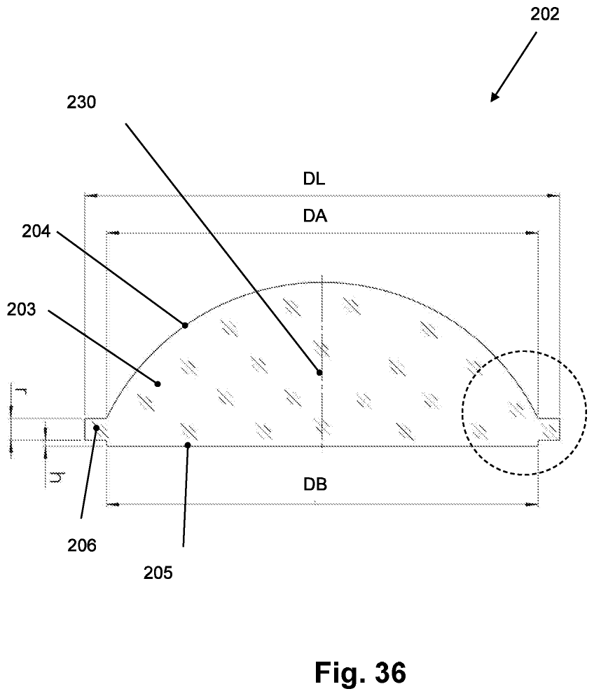

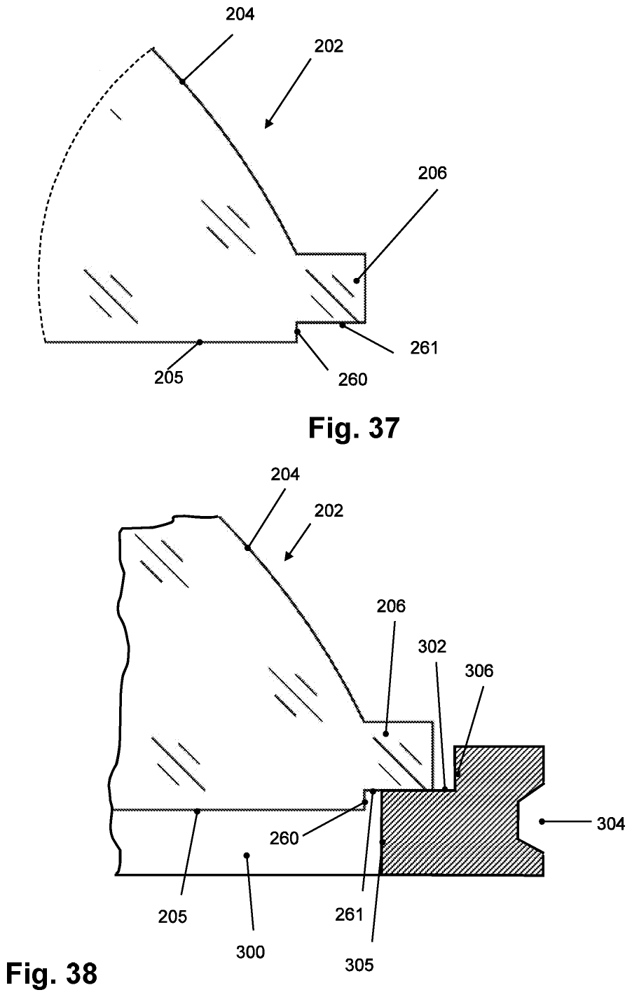

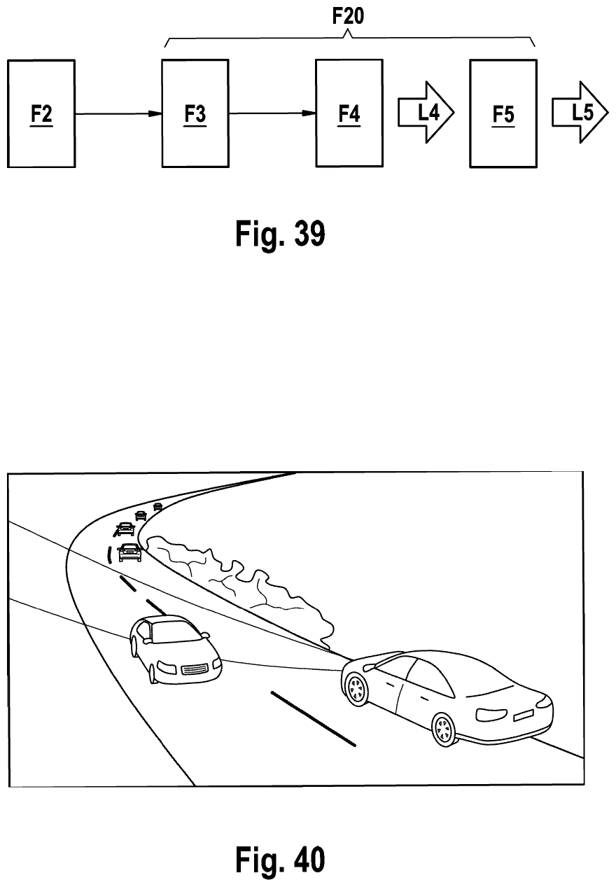

FIG. 21 shows a cross-section through an embodiment of a further protective cap 5302, FIG. 22 shows a view into the interior of the protective cap 5302 according to FIG. 21, FIG. 23 shows a perspective view of the protective cap 5302. The protective cap 5302 is also cup-shaped, but in addition to a cylindrical region 5312 also has a conical region 5342. The conical region 5342 transitions to a covering region 5322 via a curvature 5332. The conical region 5342 defines a volume that is between 30% and 50% of the volume of the cavity of the protective cap 5302.

The protective caps 5002, 5202, 5302 have for example the purpose of protecting the heating coils 5001 in the furnace against glass bursting open. If a gob bursts open in the furnace without this protective cap, some of the glass or a majority of glass clings to the heating coils 5001 and thus significantly impairs the heating process of the next gobs or even destroys the heating coils 5001 and thus the complete function of the furnace. The protective caps 5002, 5202, 5302 are removed after a gob burst and replaced by other protective caps. The protective caps 5002, 5202, 5302 are adapted to the size of the furnace.

The heating coil 5001 can consist of or comprise a plurality of independently controllable heating coils 5001A and 5001B. This independent controllability makes it possible to achieve a particularly suitable, for example homogeneous, temperature (distribution) within the furnace or within the protective caps 5002, 5202, 5303. The protective caps 5002, 5202, 5303 contribute to this desired temperature distribution in addition to their function of reducing the extent of gob bursting. For example, the protective caps consist of or comprise silicon carbide.

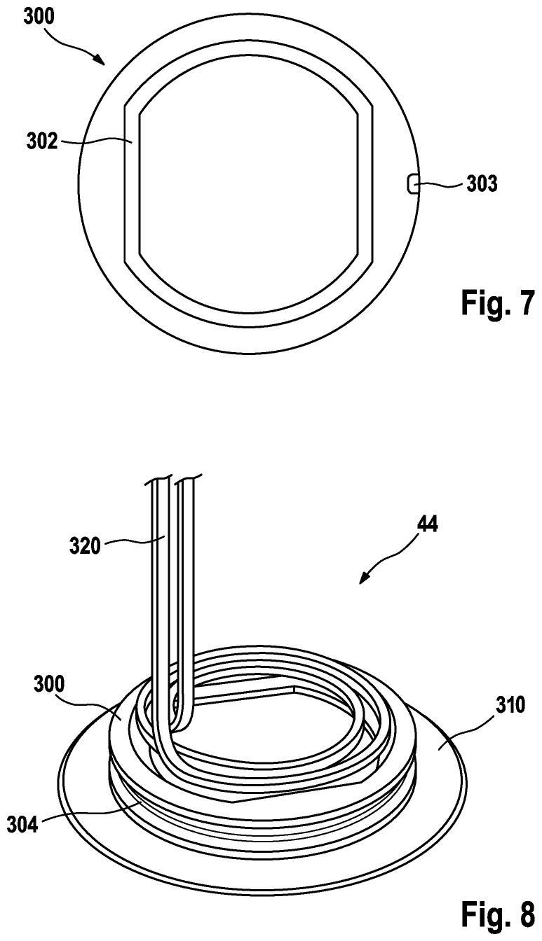

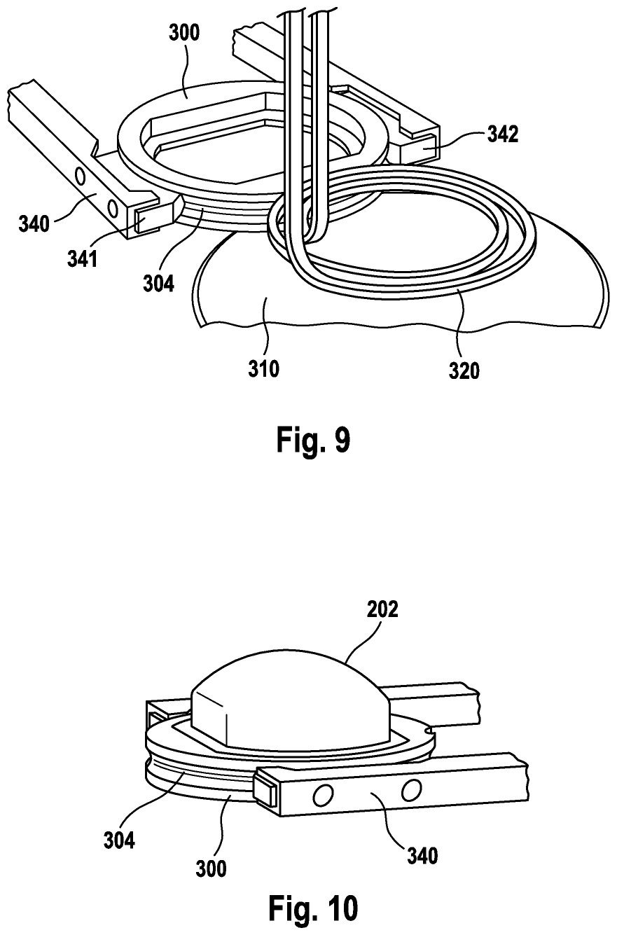

The process steps 123 and 124 are coordinated with each other—as explained below with reference to FIG. 5 and FIG. 6—in such a way that a reversal of the temperature gradient is achieved. FIG. 5 shows an exemplary preform 130 before entering the cooling apparatus 5 and FIG. 15 shows the preform 130 with a reversed temperature gradient after leaving the heating apparatus 6. While the blank is warmer on the inside than on the outside before process step 123 (with a continuous temperature profile), it is warmer on the outside than on the inside after process step 124 (with a continuous temperature profile). The wedges designated by reference signs 131 and 132 symbolize the temperature gradients, with the width of a wedge 131 or 132 symbolizing a temperature.

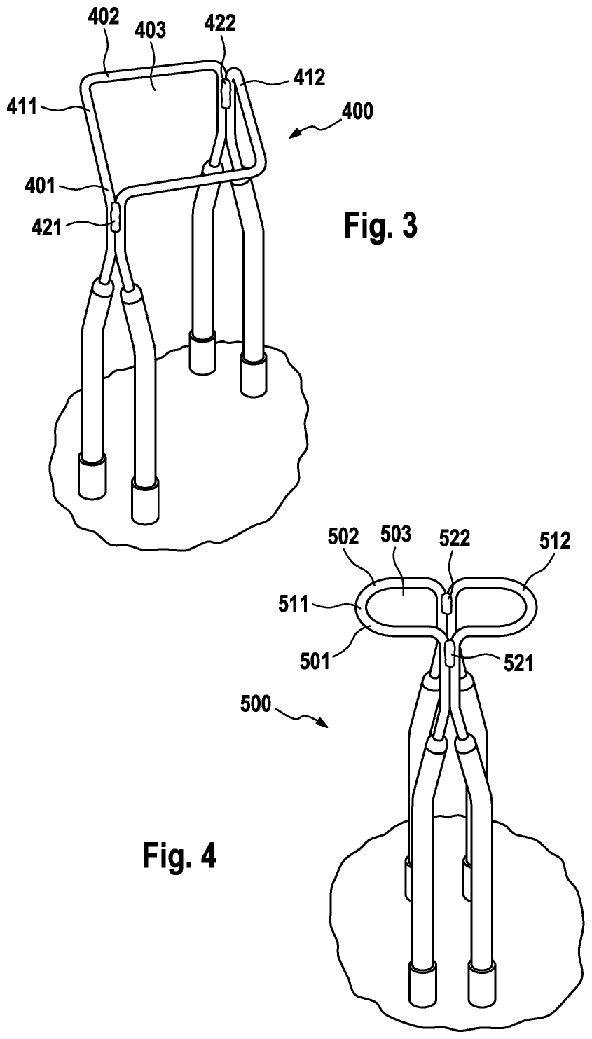

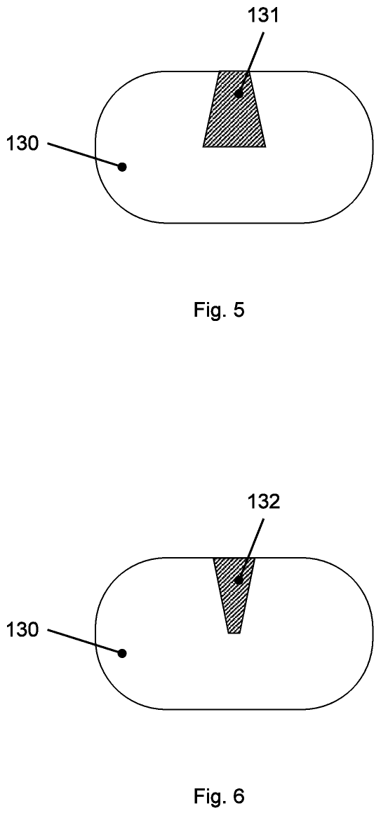

In order to turn over its temperature gradient, in an embodiment a preform lying on a cooled lance not shown is moved (for example essentially continuously) through the temperature control unit comprising the cooling apparatus 5 and the heating apparatus 6 or is held in one of the cooling apparatus 5 and/or one of the heating apparatus 6. A cooled lance is disclosed in DE 101 00 515 A1 and in DE 101 16 139 A1. Depending on the shape of the preform, FIG. 3 and FIG. 4 for example show suitable lances. For example, coolant flows through the lance in countercurrent flow. Alternatively or additionally, the coolant can be additionally or actively heated.

For the term “lance”, the term “support device” is also used in the following. The support device 400 shown in FIG. 3 comprises a supporting body 401 with a hollow cross-section and an annular support surface 402. The supporting body 401 is tubular at least in the region of the support surface 402 and is uncoated at least in the region of the support surface 402. The diameter of the hollow cross-section of the supporting body 401 is not less than 0.5 mm and/or not greater than 1 mm, at least in the region of the support surface 402. The outer diameter of the supporting body 401 is not smaller than 2 mm and/or not larger than 3 mm at least in the area of the support surface The support surface 402 spans a square base area 403 with rounded corners. The supporting body 401 comprises two flow channels 411 and 412 for the cooling medium flowing through, each of which extends only over a portion of the annular support surface 402, the flow channels 411 and 412 being connected to metallic filler material 421 and 422, for example solder, in a region in which they leave the support surface 402.

The support device 500 shown in FIG. 4 comprises a supporting body 501 with a hollow cross-section and an annular support surface 502. The supporting body 501 is tubular at least in the region of the support surface 502 and is uncoated at least in the region of the support surface 502. The diameter of the hollow cross-section of the supporting body 501 is not smaller than 0.5 mm and/or not larger than 1 mm, at least in the region of the support surface 502. The outer diameter of the supporting body 501 is not smaller than 2 mm and/or not larger than 3 mm at least in the area of the supporting surface The support surface 502 spans an oval base area 503. The supporting body 501 comprises two flow channels 511 and 512 for the cooling medium flowing through, each of which extends only over a portion of the annular support surface 502, the flow channels 511 and 512 being connected in a region in which they leave the support surface 502 by metallic filler material 521 and 522, for example solder.

It can be provided that preforms are removed after passing through the cooling apparatus 5 (as a cooling path) and are fed by means of a transport device 41, for example to an intermediate storage (e.g. in which they are stored at room temperature). In addition, it can be provided that preforms are fed to the transfer station 4 by means of a transport apparatus 42 and are phased into the further process (for example starting from room temperature) by heating in the heating apparatus 6.

Deviating from the process described with reference to FIG. 2A, in the process described with reference to FIG. 2B, process step 121 is followed by process step 122′, in which the cast gobs are transferred—by means of a transfer station 4—to a cooling path 49 of the device 1A shown in FIG. 1A. Cooling path in this sense is for example a conveyor device, such as a conveyor belt, through which a gob is guided and cooled in the process, for example with the addition of heat. The cooling is carried out to a certain temperature above room temperature or to room temperature, the gob being cooled down to room temperature in the cooling path 49 or outside the cooling path 49. It is provided, for example, that a gob in the cooling path 49 lies on a support of graphite or comprising graphite.

In the subsequent process step 123′ according to FIG. 2B, the gobs are fed to a device 1B. The devices 1A and 1B can be located in close proximity to each other or further away. In the latter case, a transfer station 4A transfers the gobs from the cooling path 49 into a transport container BOX. The gobs are transported in the transport container BOX to the device 1B, in which a transfer station 4B removes the gobs from the transport container BOX and transfers them to a hood-type annealing furnace 5000. The gobs are heated in the hood-type annealing furnace 5000 (process step 124).

Flat gobs, wafers, or wafer-like preforms can also be used to fabricate microlens arrays. Such wafers can be square, polygonal or round, for example, with a thickness of 1 mm to 10 mm and/or a diameter of 4 inches to 5 inches. In a deviation from the process described so far, these preforms are not heated on support devices as shown in FIG. 3 and FIG. 4, but are clamped in place as shown in FIG. 53. Here, reference sign T1 denotes a flat preform or wafer and reference signs T2 and T3 denote clamping devices for clamping the flat preform T1 or wafer. In this clamping arrangement T5 comprising the clamping devices T2 and T3, this flat preform is heated in a heating apparatus, such as, for example, the hood-type annealing furnace 5000. It may be provided that this preform T1 is not introduced into the heating device from below but laterally. It is further for example provided that the clamped flat preform T1 rotates in the heating device to prevent deflection of the flat preform T1. In this case, the preform T1 is heated, for example in rotation, in the heating device until the heated preform T1 can be pressed. The preform T1 is then placed in a, for example rotating, movement on a pressing mold described in more detail below, whereby the clamping devices T2 and T3 of the clamping arrangement T4 are opened so that the preform T1 rests on the pressing mold. During the pressing process, the clamping devices T2 and T3 may remain in the press. After the pressing process, the clamping devices T2 and T3 again grip the pressed preform T1 and convey the preform T1 to an area outside the press.

Behind the heating apparatus 6 or 5000, a press 8 is provided, to which a preform is transferred by means of a transfer station 7. By means of the press 8, the preform is press-molded, for example on both sides, in a process step 125 to form an optical element such as the headlight lens 202. A suitable mold set is disclosed, for example, in EP 2 104 651 B1. FIG. 24 shows a principle sketch of a press station PS for pressing an optical element from a heated blank. The press station PS is a part of the press 8 according to FIG. 1 and FIG. 1B. The press station PS has an upper press unit PO and a lower press unit PU. For pressing, a mold OF (upper mold), which is moved by means of a press drive or by means of an actuator O10, and a mold UF (lower mold), which is moved by means of a press drive or by means of an actuator U10, are moved towards each other. The mold UF is connected to a movable connector U12 on the mold side, which in turn is connected to a movable connector U11 on the actuator side by means of movable guide rods U51, U52. The actuator U10 is in turn connected to the actuator-side movable connector U11 so that the mold UF can be moved by means of the actuator U10. The movable guide rods U51 and U52 extend through recesses of a fixed guide element UO in such a way that deflection or movement of the movable guide rods U51 and U52 and thus of the mold UF perpendicular to the direction of movement is avoided or reduced or limited.

The press unit PO comprises an actuator O10, which moves the mold OF and is connected to a movable guide element O12. The press unit PO also comprises a frame formed by an actuator-side fixed connector O11 and a mold-side fixed connector O14 as well as fixed guide rods O51 and O52, which connect the actuator-side fixed connector O11 to the mold-side fixed connector O14. The fixed guide rods O51 and O52 are guided through recesses of the movable guide element O12 so that they prevent, reduce or avoid movement or deflection of the mold OF orthogonal to the direction of movement of the actuator O10 or the mold OF.

In the example shown, the PO and PU press units are linked in that the fixed guide element UO is the same as the fixed connector O14 on the mold side. With this linking or interlinking of the two press units PO and PU of the press station PS a particularly high quality (especially in terms of contour accuracy) of the headlight lenses to be pressed is achieved.

The press station 800 comprises a lower process aggregate 801 and an upper press aggregate 802 (see FIG. 25), wherein FIG. 25 shows an embodiment of a press station 800 by means of which optical elements, such as headlight lenses, can be pressed in a particularly preferred and suitable manner. The press station 800 is an embodiment of the press station PS of FIG. 24, the press aggregate 801 is an embodiment of the lower press unit PU of FIG. 24, and the press aggregate 802 is an embodiment of the upper press unit PO of FIG. 24. The press station 800 comprises a pressing frame comprising, in an exemplary embodiment, interconnected rods 811 and 814 and interconnected rods 812 and 815. The rods 811 and 812 are interconnected by a lower plate 817 and an upper connecting part 816, forming a pressing frame that receives the lower press aggregate 801 and the upper press aggregate 802.

The lower press aggregate 801 comprises a press drive 840 corresponding to the actuator U10, by means of which three rods 841, 842, 843 are movable to move a lower press mold 822 coupled to the rods 841, 842, 843, which corresponds to the form UF. The rods 841, 842, 843 are guided by holes or bores not shown in the plate 817 and a plate 821, which prevent or substantially reduce deviation or movement of the press mold 822 in a direction orthogonal to the direction of movement. The rods 841, 842, 843 are implementation examples for the movable guide rods U51 and U52 according to FIG. 24. The plate 817 is an embodiment or implementation of the fixed guide element UO.

The upper press aggregate 802 shown in FIG. 26 comprises a press drive 850 corresponding to the actuator O10, which is held by the upper connecting part 816 corresponding to the fixed connector O11 on the actuator side. By means of the press drive 850, a plate 855 corresponding to the movable guide element O12 is guided by guide rods 851, 852 and 853 and an upper press mold 823. The guide rods 851, 852 and 853 correspond to the fixed guide rods OS1 and OS2 in FIG. 24. The press mold 823 corresponds to the mold OF in FIG. 24. For guiding, sleeves H851, H852 and H853 with bearings L851 and L853 are also provided as implementation of the recesses of the movable guide plate O12 of FIG. 24, which enclose the guide rods 851, 852 and 853. Plates 821 and 817 are fixed to each other to form the fixed guide element UO (plate 817) and the mold-side fixed connector O14 (plate 821).

Reference numeral 870 denotes a movement mechanism by means of which an induction heater 879 with an induction loop 872 can be traversed to the lower mold 822 in order to heat it by means of the induction loop 872. After heating by means of the induction loop 872, the induction heater 879 is moved back to its initial position. A gob or preform is deposited on the press mold 822 and is press-molded (on both sides) by moving the press mold 822 and 823 towards each other to form a headlight lens.

FIG. 27 shows a further press station 800′ also as an example of the press station PS according to FIG. 24. In a modification to press station 800, a stiffening profile P811, P812 is provided, for example in each case, fora rod 811, 812 or fora rod 814, 815, respectively, the stiffening profile P811, P812 being connected to the rods 811, 812, 814, 815 via clamps SP811, SP812, SP814, SP815. FIG. 28 shows an example of a detailed view of such a clamp SP811, where one half of the clamp is welded to the stiffening profile P811.

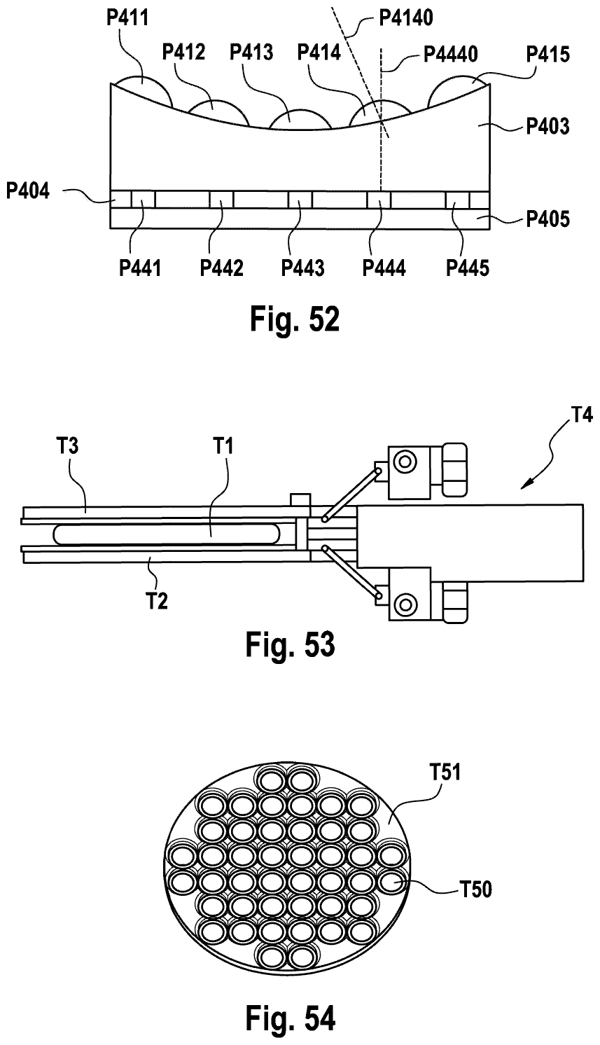

For example, the components are matched and/or dimensioned in such a way that the maximum tilt ΔKIPOF or the maximum angle of tilt of the mold OF (corresponding to the angle between the target pressing direction ACHSOF* and the actual pressing direction ACHSOF), as shown in FIG. 29, is not greater than 10⁻²° for example is not greater than 5·10⁻³°. Furthermore, it is provided that the radial offset ΔVEROF, i.e. the offset of the mold OF from its target position in the direction orthogonal to the target pressing direction ACHSOF* is not more than 50 μm, for example not more than 30 μm, or not more than 20 μm, or not more than 10 μm.

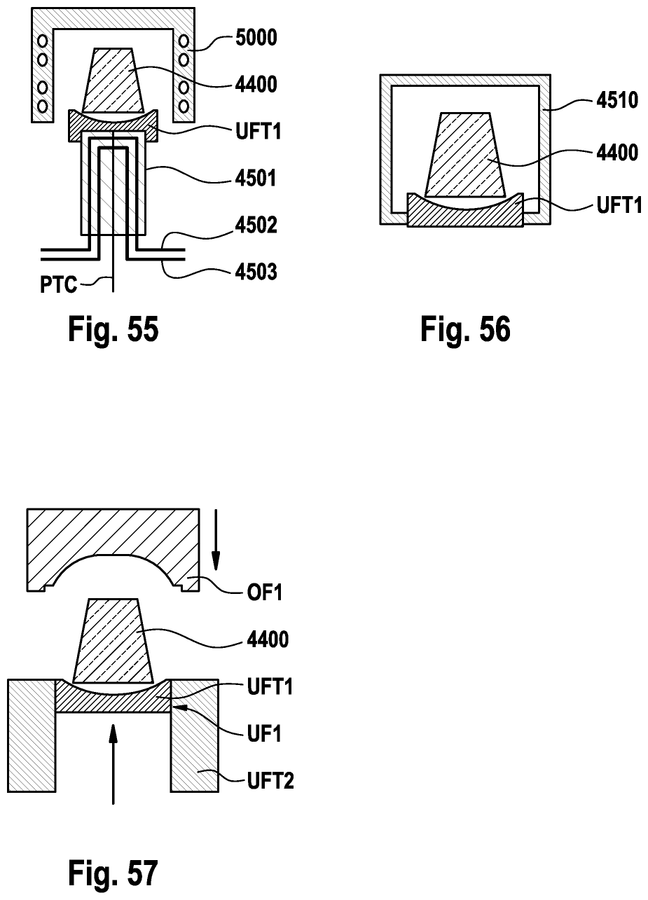

For example, the components are matched and/or dimensioned in such a way that the maximum tilt ΔKIPUF or the maximum angle of tilt of the mold UF (corresponding to the angle between the target pressing direction ACHSUF* and the actual pressing direction ACHSUF), as shown in FIG. 30, is not greater than 10⁻²° for example not greater than 5·10⁻³°. Furthermore, it is provided that the radial offset ΔVERUF, i.e. the offset of the mold UF from its target position in the direction orthogonal to the target pressing direction ACHSUF* is not more than 50 μm, for example not more than 30 μm, or not more than 20 μm, or not more than 10 μm.

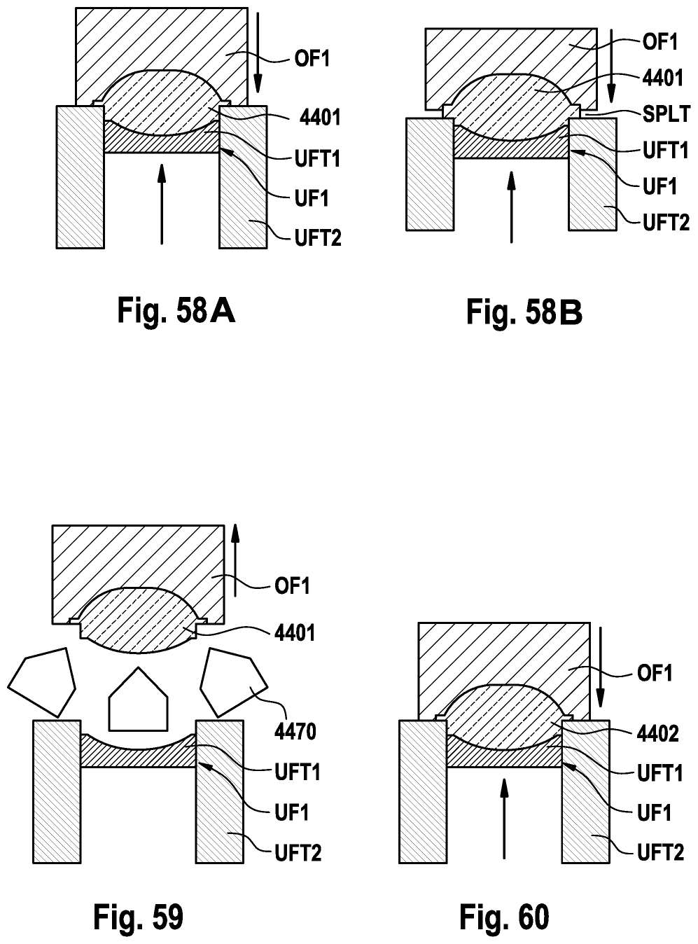

Additionally or alternatively, it can be provided that the actuator O10 is decoupled in terms of torsion from the movable guide element O12 with the mold OF. Furthermore, it can be provided that the actuator U10 is also decoupled in terms of torsion from the mold-side movable connector U12 with the mold UF. Such decoupling is shown in FIG. 31 using the example of decoupling the actuator O10 from the mold OF with the movable guide element O12. The decoupling piece, which comprises the ring ENTR and the washers ENTS1 and ENT2, prevents torsion of the actuator O10 from acting on the mold OF.

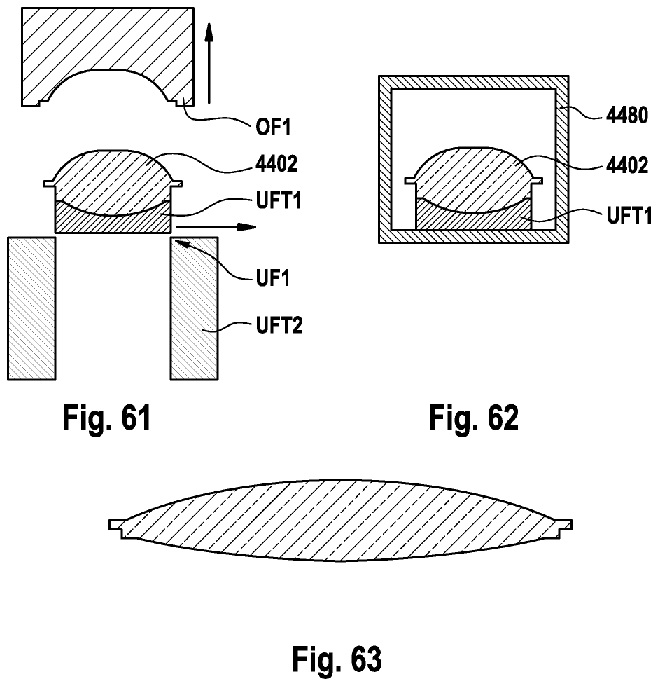

The process described can also be carried out in conjunction with pressing under vacuum or near-vacuum or at least negative pressure in a chamber, as disclosed by way of example in JP 2003-048728 A. The described method can also be carried out in connection with pressing under vacuum or near vacuum or at least negative pressure by means of a bellows, as explained below by way of example in FIG. 32 with reference to the press station PS. In this case, it is envisaged that a bellows BALG is provided or arranged between the movable guide element O12 and the mold-side movable connector U12 for airtight sealing or at least substantially airtight sealing of the molds OF and UF. Suitable methods are disclosed, for example, in the above-mentioned JP 2003-048728 A (incorporated by reference in its entirety) and in WO 2014/131426 A1 (incorporated by reference in its entirety). In a corresponding embodiment, a bellows as at least similarly disclosed in WO 2014/131426 A1 may be provided. It may be provided that the pressing of an optical element such as a headlight lens is performed by means of at least one lower mold UF and at least one upper mold OF,
(a) wherein the heated preform or blank or gob 4001 (glass) is placed in or on the lower mold UF,
(b) wherein (subsequently or thereafter) the upper mold OF and the lower mold UF are (to each other positioned and) moved towards each other without the upper mold OF and the lower mold UF forming a closed overall mold, (for example to such an extent that the distance (for example the vertical distance) between the upper mold and the blank is not less than 4 mm and/or not more than 10 mm).
(c) wherein (subsequently or thereafter) the bellows BALG is closed to create an airtight space in which the upper mold OF and the lower mold UF are arranged,
(d) wherein (subsequently or thereafter) a vacuum or near-vacuum or negative pressure is created in the airtight space,
(e) wherein (subsequently or thereafter) the upper mold OF and the lower mold UF are moved (for example vertically) towards each other for (for example two-sided or all-sided) (press-) molding of the optical lens element, wherein for example it is provided that the upper mold OF and the lower mold UF touch each other or form a closed overall shape (the upper mold OF and the lower mold UF can be moved towards each other in that the upper mold OF is moved (vertically) towards the lower mold UF and/or the lower mold UF is moved (vertically) towards the upper mold OF).
(f) wherein subsequently or thereafter normal pressure is generated in the airtight space,
(g) wherein subsequently or thereafter in further embodiment the seal is opened or returned to its initial position,
(h) and wherein subsequently or thereafter or during step (f and/or g) the upper mold OF and the lower mold UF are moved apart.

In a further embodiment, a predetermined waiting time is waited before pressing the optical element such as a headlight lens (or between step (d) and step (e)). In further embodiment, the predetermined waiting time is not more than 3 s (minus the duration of step (d)). In a further embodiment, the predetermined waiting time is not less than 1 s (minus the duration of step (d)).

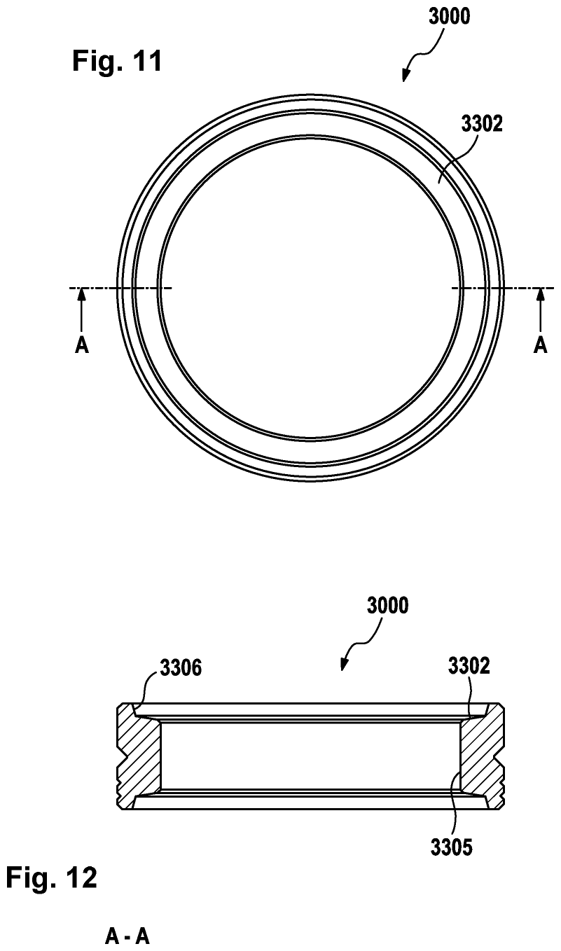

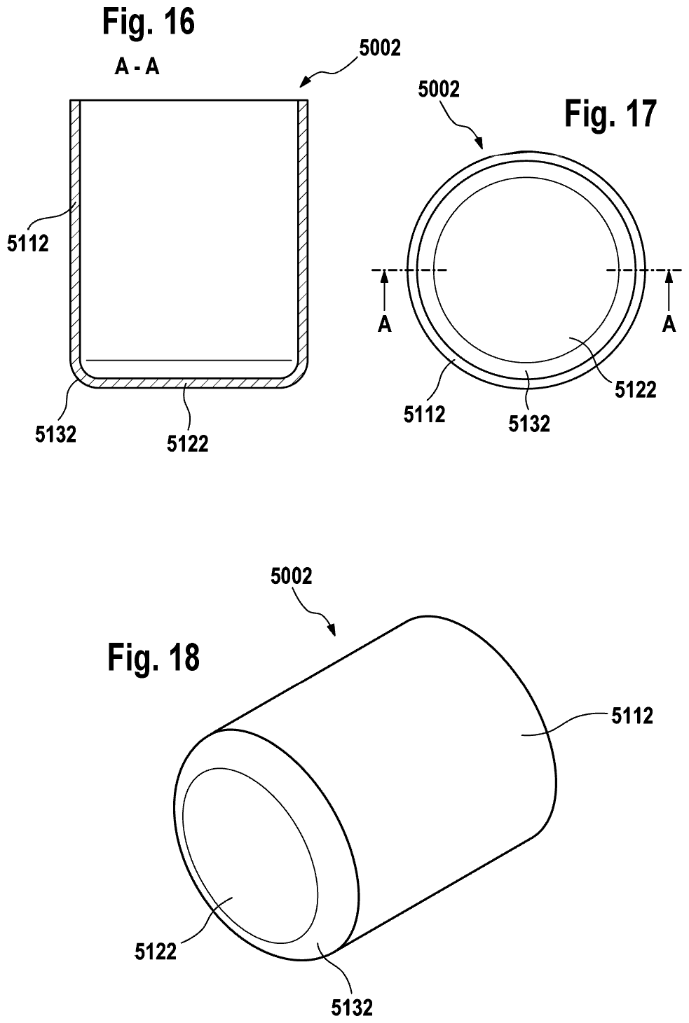

Following pressing, the optical element (such as a headlight lens) is deposited by means of a transfer station 9 on a transport element 300 shown in FIG. 7. The ring-shaped transport element 300 shown in FIG. 7 is made of steel, for example ferritic or martensitic steel. The annular transport element 300 has a (corresponding) support surface 302 on its inner side, on which the optical element to be cooled, such as the headlight lens 202, is placed with its edge, so that damage to the optical surfaces, such as the surface 205, is avoided. For example, the (corresponding) support surface 302 and the support surface 261 of the lens edge 206 come into contact, as shown, for example, in FIG. 38. In this regard, FIG. 10 and FIG. 38 show the fixation or alignment of the headlight lens 202 on the transport element 300 by means of a limiting area 305 and a limiting area 306, respectively. The limiting areas 305 and 306 are for example orthogonal to the (corresponding) support surface 302. It is provided that the limiting areas 305, 306 have sufficient clearance with respect to the headlight lens 202 so that the headlight lens 202 can be placed on the transport element 300, for example without the headlight lens 202 tilting or jamming on the transport element 300.

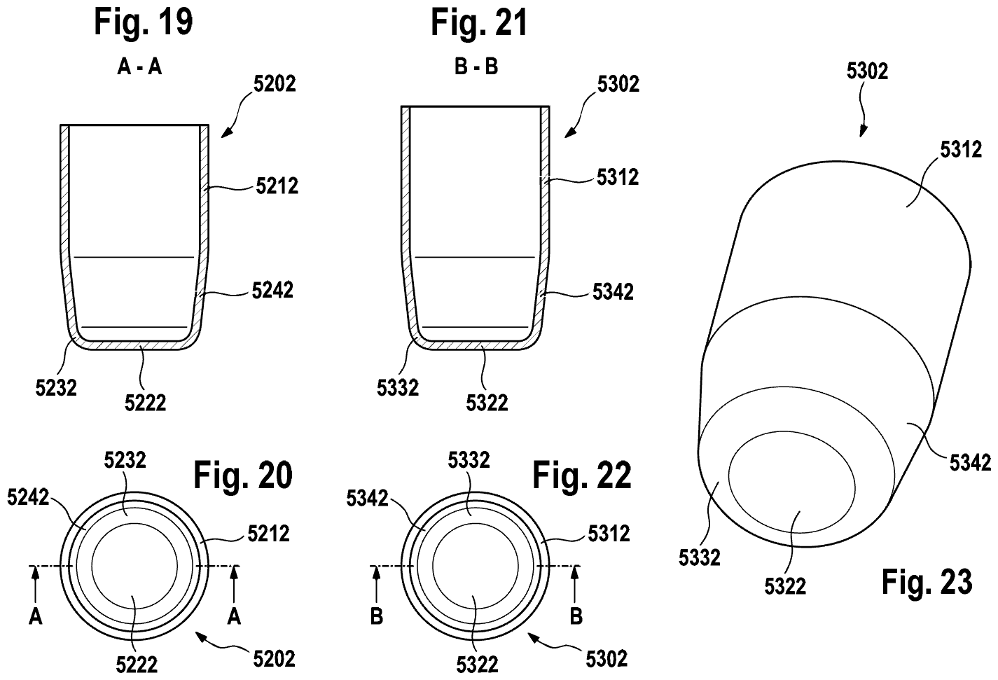

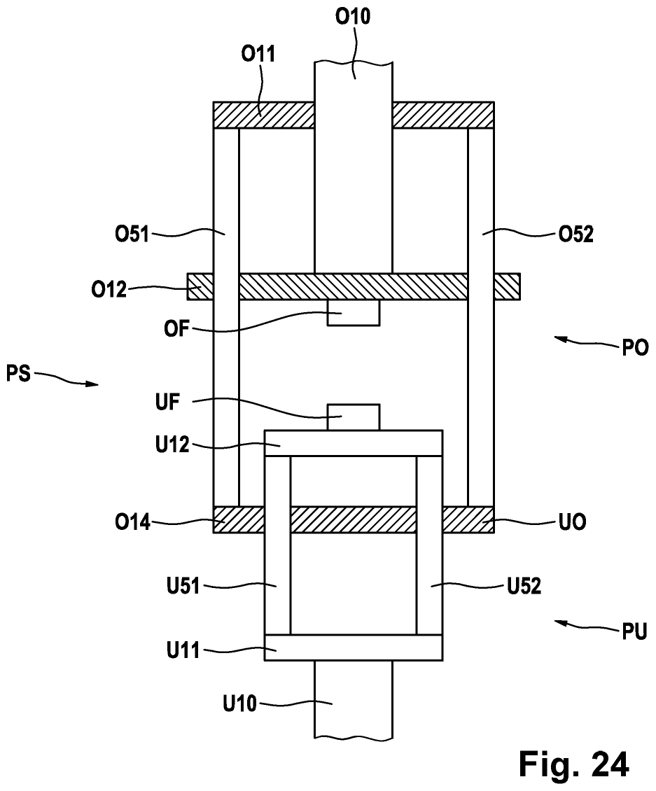

FIG. 11 shows a transport element 3000 designed as an alternative to the transport element 300, which is shown in a cross-sectional view in FIG. 12. Unless otherwise described, the transport element 3000 has a similar or identical or analogous design to the transport element 300. The transport element 3000 (also) has limiting areas 3305 and 3306. In addition, a supporting surface 3302 is provided, which, however, in a modification to the supporting surface 302, is designed to slope downwards in the direction of the center of the transport element 3000. For example, it is provided that the limiting area 3305 and 3306 have sufficient clearance with respect to the headlight lens 202, whereby a particularly precise alignment is achieved by the slope of the supporting surface 3302. The handling of the transport element 3000 is otherwise carried out in an analogous manner to the following description of the handling of the transport element 300. The angle of the slope or inclination of the support surface 3302 relative to the orthogonal of the axis of rotation or, in the case of intended use, relative to the support plane, is between 5° and 20°, in the shown embodiment 10°.

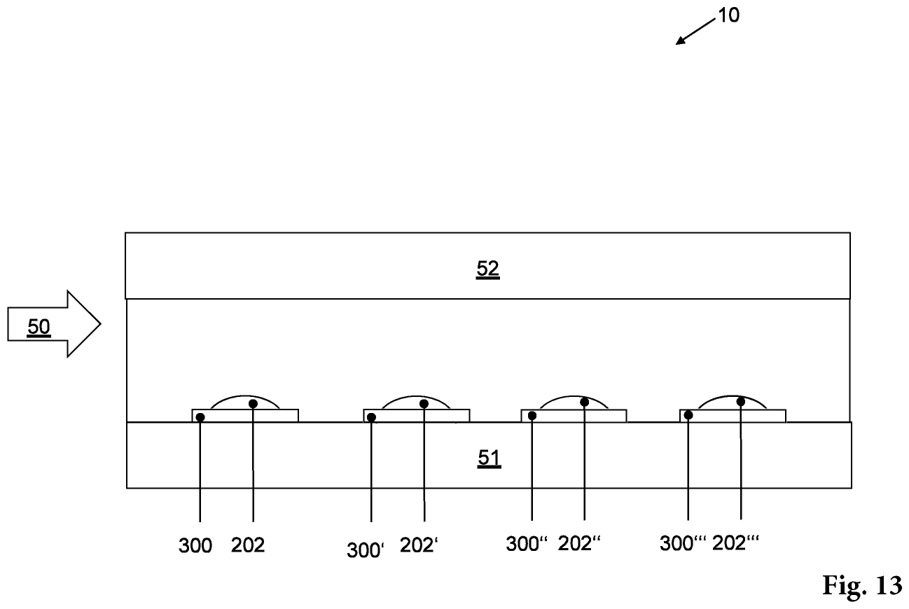

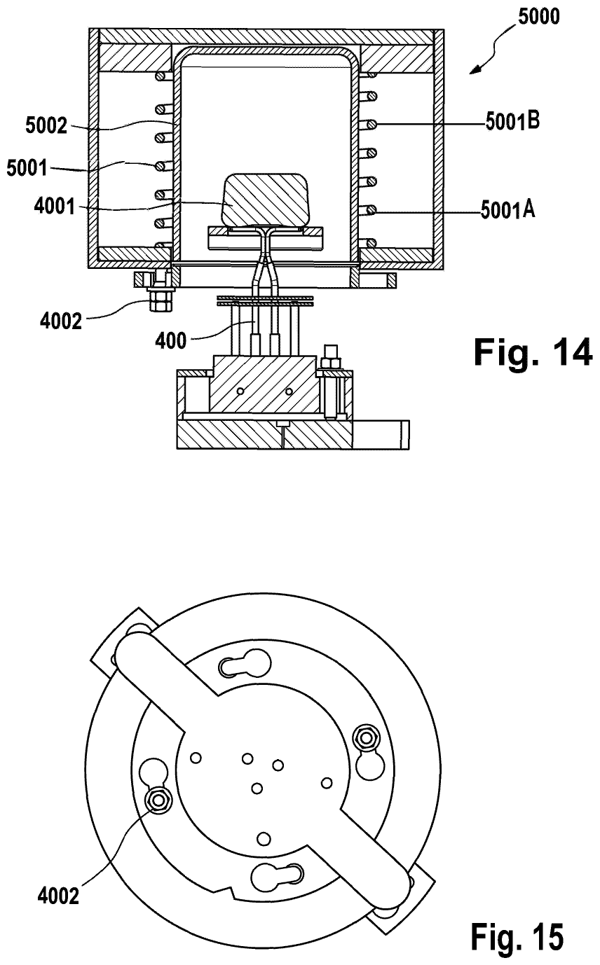

In addition, the transport element 300 is heated before the headlight lens 202 is placed on the transport element 300, so that the temperature of the transport element 300 is approximately +−50K of the temperature of the headlight lens 202 or the edge 206. For example, the heating is performed in a heating station 44 by means of an induction coil 320, as shown in FIG. 8 and FIG. 9. In this process, the transport element 300 is placed on a support 310 and heated by means of the induction coil/induction heater 320 for example at a heating rate of 30-50K/s, for example within less than 10 seconds. Subsequently, the transport element 300 is gripped by a gripper 340 as shown in FIG. 9 and FIG. 10, respectively. For example, the transport element 300 has an indentation 304 on its outer edge, which in an embodiment is designed to be circumferential. For correct alignment, the transport element 300 has a marking groove 303. By means of the gripper 340, the transport element 300 is moved to the press 8 and the headlight lens 202 is transferred from the press 8 to the transport element 300 and deposited on it, as shown in FIG. 10.

In a suitable embodiment, it is provided that the support 310 is configured as a rotatable plate. Thus, the transport element 300 is placed on the support 310, which is designed as a rotatable plate, by hydraulic and automated movement units (e.g. by means of the gripper 340). Subsequently, centering is performed by two centering jaws 341 and 342 of the gripper 340 and in such a way that the transport element undergoes the alignment defined by the marking groove 303, which is or can be detected by means of a position sensor. As soon as this transport element 300 has reached its linear end position, the support 340, which is configured as a rotary plate, begins to rotate until a position sensor has detected the marking groove 303.

In a process step 126, an optical element, for example headlight lens 202, is moved on the transport element 300 through a surface treatment station 45. In this process, the optically effective surface 204 of the headlight lens 202 is sprayed with surface treatment agent by means of a dual-substance nozzle 450, and at least one optically effective surface of the optical element such as the optically effective surface 205 of the headlight lens 202 is sprayed with surface treatment means by means of a dual-substance nozzle 45u. The spraying process takes no more than 12 seconds, for example no more than 8 seconds, for example no less than 2 seconds. The dual-substance nozzles 45o and 45u each comprise an inlet for atomizing air and an inlet for liquid, in which the surface treatment agent is supplied, converted into a mist or spray by means of the atomizing air and exits through a nozzle. A control air port is also provided for controlling the dual-substance nozzles 45o and 45u, which is controlled by means of a control arrangement 15 described below.

By means of the proposed process for manufacturing an optical element or a headlight lens, a weathering resistance or hydrolytic resistance comparable to borosilicate glass is achieved. In addition, the costs for the producing process increase only slightly compared to the manufacturing process of optical elements or headlight lenses with a weathering resistance or hydrolytic resistance corresponding to soda-lime glass.

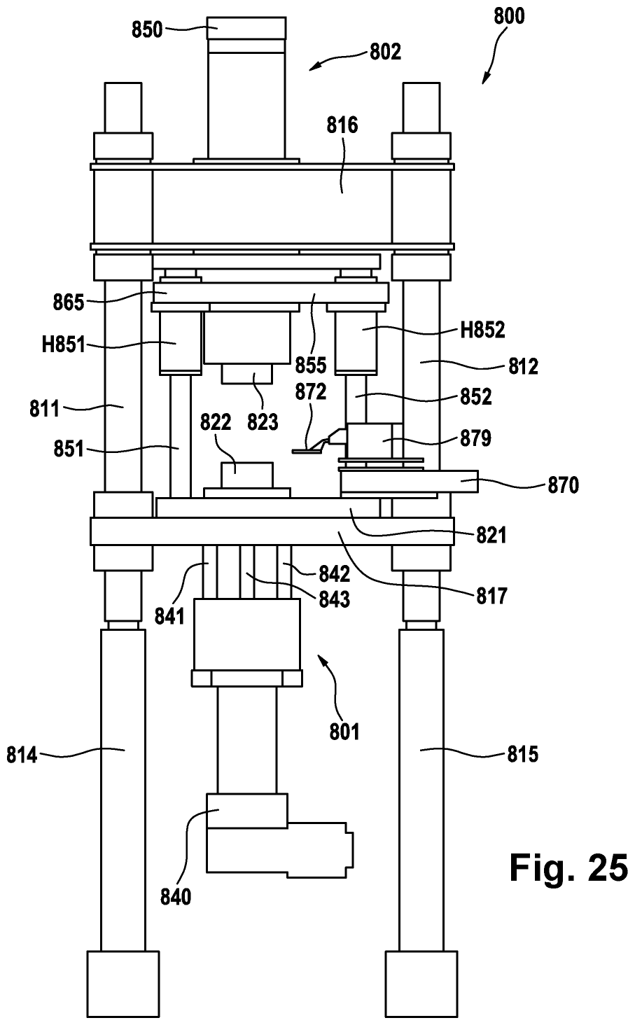

The transport element 300 with the headlight lens 202 is then placed on the cooling path 10. The cooling path 10 is used to cool the headlight lens 202 in a process step 127. FIG. 13 shows the exemplary cooling path 10 from FIG. 1 in a detailed principle illustration. The cooling path 10 comprises a heated or heatable tunnel by means of a heating apparatus 52, through which the headlight lenses 202, 202′, 202″, 202′″ are slowly moved on transport elements 300, 300′, 300″, 300′″ in a direction indicated by an arrow 50. Thereby, the heating power decreases in the direction of movement of the transport elements 300, 300′, 300″, 300′″ with the headlight lenses 202, 202′, 202″, 202′″. For moving the transport elements 300, 300′, 300″, 300′″ with the headlight lenses 202, 202′, 202″, 202′″, for example, a conveyor belt 51, for example made of chain links or implemented as an array of rollers, is provided.

At the end of the cooling path 10, a removal station 11 is provided, which removes the transport element 300 together with the headlight lens 202 from the cooling path 10. In addition, the removal station 11 separates the transport element 300 and the headlight lens 202 and transfers the transport element 300 to a return transport apparatus 43. From the return transport apparatus 43, the transport element 300 is transferred by means of the transfer station 9 to the heating station 44, in which the transport element 300 is placed on the support 310 designed as a rotary plate and heated by means of the induction heating 320.

Finally, a process step 128 follows in which residues of the surface treatment agent on the lens are washed off in a washing station 46.

It may be envisaged that, with reference to the heating of a flat gob, microlens arrays are pressed which are not used as an array but their individual lenses. Such an array is shown, for example, in FIG. 54, which shows a plurality of individual lenses T50 on an array T51 created by pressing. In such a case, it is intended to separate the individual lenses T50 of the array T51.

The device shown in FIG. 1 further comprises a control arrangement 15, for controlling or regulating the device 1 shown in FIG. 1. The device 1A shown in FIG. 1A further comprises a control arrangement 15A, for controlling or regulating the device 1A shown in FIG. 1A. The device 1B shown in FIG. 1B further comprises a control arrangement 15B, for controlling or regulating the device 1B shown in FIG. 1B. The control arrangements 15, 15A and 15B thereby may provide for a continuous linkage of the individual process steps.

The terms preform and blank are used synonymously.

As an alternative or modification to the supporting bodies 401 and 501, respectively, of FIG. 3 and FIG. 4, FIG. 55 shows the support of a blank 4400 made of glass on a molded part, which in the present embodiment is a lower mold part UFT1. Here, for example, it is provided that the bottom side of the blank 4400 has a radius of curvature that is larger than the radius of curvature of the concave shaped lower mold part UFT1. Accordingly, the blank 4400 resting on the lower mold part UFT1 can be heated by means of a hood-type annealing furnace 5000 described in FIG. 14. For details with respect to the hood-type annealing furnace 5000 described in FIG. 55, please refer to the description with respect to FIG. 14.

A cooling block 4501 is provided for cooling the lower mold part UFT1, which can be cooled by at least one cooling channel 4502 or 4503 and thus cools the lower mold part UFT1. At least one temperature sensor PTC is provided for controlling the cooling. In an embodiment, several, but at least two, independent cooling channels 4502 and 4503 are provided, which can be set independently of one another or whose flows can be set independently of one another. For example, it is provided that the independent adjustability serves to form a desired temperature distribution in the cooling block 4501 or/and thus in the lower mold part UFT1. In the embodiment example shown in FIG. 55, two independently adjustable cooling channels 4502 and 4503 are shown. However, more cooling channels may be provided that are independently adjustable. The independence of the cooling channels 4502 and 4503 or, if applicable, further cooling channels relates to (or may relate to), among other things, the cooling medium, the coolant quantity, the coolant speed and/or the coolant temperature.

Subsequently, the process step for pressing the blank 4400 into an optical element 4402, which corresponds, for example, to the optical element 202, can take place. Pressing may be performed as described with reference to FIG. 24, FIG. 25, FIG. 26, FIG. 27 and FIG. 28. In addition or modification, a housing 4510 may be provided in which the heated blank 4400 is transported on the lower mold part UFT1 for pressing. In this way, undesirable cooling of the blank 4400 between heating in the hood-type annealing furnace 5000 and the press unit or press 8 is reduced or avoided.

As an alternative or modification to the pressing provided with reference to FIG. 24, FIG. 25, FIG. 26, FIG. 27 or FIG. 28, it can be provided that the lower mold UF or 822 is (at least) in two parts. In this case, the lower mold UF1 corresponding to the lower mold UF or 822 can comprise the lower mold part UFT1 and a further lower mold part UFT2 surrounding the lower mold part UFT1, as shown in FIG. 56 and in FIG. 57. The press shown in FIG. 57 also comprises an upper mold OF1, which can correspond to the upper mold OF shown in FIG. 24 or to the upper mold 823 shown in FIG. 25.

In a modification or supplement to the method described with reference to FIG. 24, FIG. 25, FIG. 26, FIG. 27 or FIG. 28, it can be provided that an intermediate molded part 4401, rather than an optical element, is first pressed from the preform or blank 4400 by the pressing process, as shown in FIG. 58A and FIG. 58B. In this case, the upper mold OF1 and the lower mold UF1 are moved toward each other, but in the alternative method shown in FIG. 58B without the upper mold OF1 and the lower mold UF1 touching each other or without the upper mold OF1 and the lower mold part UFT2 touching each other. Thus, it can be seen in FIG. 58B that a gap SPLT is shown between the upper mold OF1 and the lower mold part UFT2, which gap is not undercut. For example, it is provided that the gap SPLT or its gap height is at least 0.5 mm. In a further embodiment, it may be provided that the gap SPLT or its gap height is at least 2 mm. In a further embodiment, it may be provided that the gap SPLT or its gap height is at least 3 mm. However, it is for example intended that the gap SPLT or its gap height is not greater than 10 mm.

Following the process described with reference to FIG. 58A or FIG. 58B, the upper mold OF1 and the lower mold UF1 are moved apart as described in FIG. 59. In this process, the intermediate molded part 4401 is removed from the lower mold by a vacuum in a channel of the upper mold OF1, which is not shown. Subsequently, this is heated on the side facing the lower mold UF1 by means of heating apparatus 4470. This heating can be carried out, for example, by a gas flame or by means of heating coils.

Following the heating of the intermediate molded part 4401 by means of the heating apparatus 4470, the upper mold OF1 and the lower mold UF1 are again moved towards each other, as shown in FIG. 60. Here, in contrast to the process step as described in FIG. 58B, the mold formed by the lower mold UF1 and the upper mold OF1 is closed. For this purpose, the upper mold OF1 and the lower mold part UFT2 are moved towards each other in such a way that they touch and thus form a closed mold. By post-pressing by means of the lower mold part UFT1, for example the heated side or surface of the intermediate molded part 4401 is formed into the optically effective surface of the optical element 4402. The pressing step according to FIG. 60 presses the intermediate molded part 4401 into the optical element 4402.

The pressing step described with reference to FIG. 60 is followed by a process step as described in FIG. 61 in which the lower mold UF1 and the upper mold OF1 are moved apart. Subsequently, it may be provided that the optical element 4402 is removed from the mold or the lower mold UF1 or the lower mold part UFT1 and is cooled analogously to the process described with reference to FIG. 7, FIG. 8, FIG. 9, FIG. 10, FIG. 11, FIG. 12 and/or FIG. 13. However, it may also be provided that the optical element 4402 is modified in a manner analogous to the method described with reference to FIG. 7, FIG. 8, FIG. 9, FIG. 10, FIG. 11, FIG. 12 and/or FIG. 13, as described in FIG. 62. In this case, the optical element 4402 is not removed from the lower mold part UFT1 and is also not deposited on a transport element such as the transport element 300, but is removed from the press 8 together with the lower mold part UFT1. Subsequently, the optical element 4402 on the lower mold part UFT1 passes through a cooling path 4480 corresponding to the cooling path 10, in which the optical component 4402 is cooled according to a cooling regime, as shown in FIG. 62.

It may further be provided that the optical element 4402 is further exposed to surface treatment agent or sprayed by means of a surface treatment agent, as described with reference to FIG. 33. Thereby, in a modification to the surface treatment station 45 according to FIG. 33, it is provided that only the surface of the optical element 4402 facing away from the lower mold part UFT1 is sprayed with surface treatment agent or exposed to at least a spray mist by means of a dual-substance nozzle 450. This is done with reference to the method described in FIG. 33.

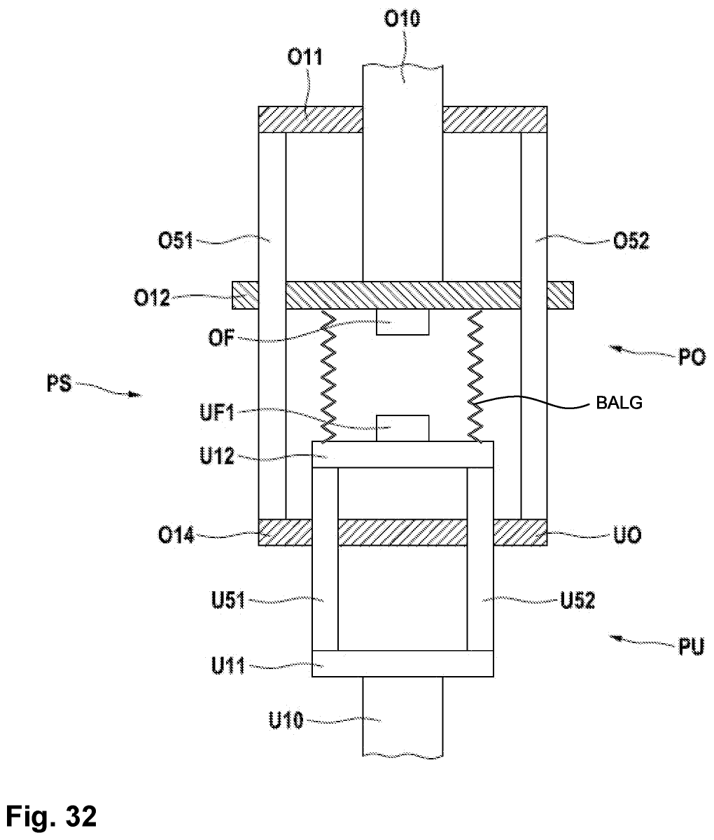

The processes described with reference to FIG. 55, FIG. 56, FIG. 57, FIG. 58A, FIG. 58B, FIG. 59, FIG. 60, FIG. 61 and/or FIG. 62 can be integrated individually or in groups or more than one into the process sequence described with reference to FIG. 1 to FIG. 33. For example, the heating process described with reference to FIG. 5 using a cooling block 4450 can be replaced or modified. In addition, the procedure for heating a preform described with reference to FIG. 14 may be followed by the procedure described in FIG. 56. It may also be provided that pressing the optical element 202 as described with reference to FIG. 24, FIG. 25, FIG. 26, FIG. 27, FIG. 28, FIG. 29, FIG. 30, FIG. 31 and/or FIG. 32 is replaced by pressing an intermediate preform 4401, i.e., a two-stage pressing as described with reference to FIG. 58A, FIG. 58B, FIG. 59 and FIG. 60. Here, among other things, in a modification of the method described with reference to FIG. 25, the heating apparatus 872 can be used or employed instead of the heating apparatus 4470.

It may be provided that the heating apparatus 4470 has a dual function for implementing the second heating step. This is done, for example, in connection with the second heating step or during the second heating step when the lower mold part remains in the press. For example, the heating apparatus 4470 for implementing the second heating step can be provided both for heating the bottom side of the intermediate molded part 4401 and for heating the lower mold part UFT1 (and, if necessary, also the lower mold part UFT2) before receiving a blank 4400. When implementing the method according to FIG. 57, FIG. 58A, FIG. 58B, FIG. 59, and FIG. 60, i.e., pressing an intermediate molded part 4401, the heating apparatus 872 serves, for example, or can serve, as an implementation of the heating apparatus 4470 (e.g., as an induction heater or radiant heater).

The described method, for example the method described with reference to modification or partial modification according to FIG. 55, FIG. 56, FIG. 57, FIG. 58A, FIG. 58B, FIG. 59, FIG. 60, FIG. 61 and/or FIG. 62, is used or applied for example for pressing biconvex lenses. For example, the method is particularly suitable for pressing biconvex lenses as disclosed in FIG. 63, as an example of an embodiment, or as disclosed in WO 2007/031170 A1.

The lens 4402 or the lens shown in FIG. 63 has a first convexly curved optically effective surface and a second convexly curved optically effective surface. It may be provided that the lens includes an integrally formed edge (having a volume). It may further be provided that a step is provided between the integrally formed lens edge and the second optically effective surface. The step may be configured to taper toward the second optically effective convexly curved surface. In this regard, the taper may be at a typical demolding angle. For example, a suitable angle is greater than 3 degrees. It may be provided that the height of the step is subject to tolerance to accommodate variations in gob volume. However, it may also be provided that the thickness of the formed lens edge, i.e. its extension in orientation of the optical axis of the lens, is subject to tolerances. This is for example the case or provided if the mold OF1 is designed in two parts, for example similar to the division of the mold UF1 into a lower mold part UFT1 and a lower mold part UFT2.

The elements in FIG. 1, FIG. 1A, FIG. 1B, FIG. 5, FIG. 6, FIG. 13, FIG. 24, FIG. 27, FIG. 28, FIG. 29, FIG. 30, FIG. 32, FIG. 33, FIG. 34, FIG. 38, FIG. 39, FIG. 42, FIG. 43, FIG. 44 and FIG. 45, FIG. 46, FIG. 47, FIG. 52, FIG. 53, FIG. 54, FIG. 55, FIG. 56, FIG. 57, FIG. 58A, FIG. 58B, FIG. 59, FIG. 60, FIG. 61, FIG. 62 and FIG. 63 are drawn with respect to simplicity and clarity and not necessarily to scale. For example, the scales of some elements are exaggerated relative to other elements to enhance understanding of the embodiments of the present disclosure.

The claimed or disclosed process makes it possible to expand the range of applications for press-molded lenses, for example, with respect to lenses, projection displays, microlens arrays and/or, for example, adaptive vehicle headlights.

The disclosure provides for an improved manufacturing process for optical elements or (optical) lenses. Thereby, a particularly high contour fidelity and/or surface quality for optical elements or lenses or headlight lenses is achieved. In addition, the costs of a producing process for optical elements or (optical) lenses and/or headlights, microprojectors or vehicle headlights are reduced.

### LIST OF REFERENCE SIGNS

1, 1A, 1B device
2 melting unit
2B adjustable outlet
3 preform device
4, 4A, 4B transfer station
5A, 5B, 5 cooling apparatus
6A, 6B, 6C heating apparatus
7 transfer station
8 press station
9 transfer station
10 cooling path
11 removal station
15, 15A, 15BS control assembly
20 motor vehicle
41 transport apparatus
42 transport apparatus
43 return transport apparatus
44 heating station
45 surface treatment station
45o dual-substance nozzle
45u dual-substance nozzle
46 washing station
50 arrow
51 conveyor belt
52 heating apparatus
120 process step
121 process step
122, 122′ process step
123, 123′ process step
124, 124′ process step
125 process step
126 process step
127 process step
128 process step
130 preform
131 temperature gradient
132 temperature gradient
201, 201′, 201″ motor vehicle headlight
202 headlight lens
203 lens body
204 substantially convex (for example optically effective) surface
205 substantially planar (for example optically effective) surface
206 lens edge
210 light source
212 reflector
214 shield
215 edge
220 bright dark boundary
230 optical axis from 202
260 step from 206
261 surface of the lens edge 206
300, 3000 transport element
302, 3302 support surface
303 marking groove
304 indentation
305, 3305 limiting area
306, 3306 limiting area
310 support
320 induction coil/induction heater
340 gripper
341, 342 centering jaws
400, 500 support devices
401, 501 supporting body
402, 502 support surface
403, 503 base area
411, 511 flow channels
412, 512 flow channels
421, 521 metallic filler material
422, 522 metallic filler material
800 press station
801 press aggregate
802 press aggregate
811, 812, 814, 815 rod
816 upper connecting part
817 lower plate
821 plate
822 lower press mold
823 upper press mold
840 press drive
841, 842, 843 rods
850 press drive
851, 852, 853 guiding rods
H851, H852, H853 sleeves
L851, L853 bearing
855 plate
870 movement mechanism
872 induction loop
879 induction heating
4001 gob
4002 nut
5000 hood-type annealing furnace
5001 heating coil
5002, 5202, 5302 protective cap
5112, 5212, 5312 cylindrical range
5132 rounded range
5122, 5222, 5322 covering range
5242, 5342 conical range
5232, 5332 curvature
4400 blank
4401 intermediate molded part
4402 optical element
4470 heating apparatus
4480 cooling path
4501 cooling block
4502, 4503 cooling channel
DA diameter from 204
DB diameter from 205
DBq orthogonal diameter to DB
DL diameter from 202
DLq orthogonal diameter to DL
F2 environmental sensoric
F3 controller
F4 illumination device
F5 objective
F20, F201 vehicle headlight
F41 light source arrangement
F42 attachment optics
F421 light exit area of F4
L4 light
L41 light irradiated in F42
L5 lighting pattern
V1 attachment optics array
V2 attachment optics
V11, V12, V13, V14, V15 attachment optics
V20 base part
V21 surface from V20
V111, V121, V131,
V141, V151 light entrance area
V115, V125, V135,
V145, V155 side areas
V2011, V2012, V2013,
V2014, V2015 lenses
V11
VL light source arrangement
M2 environmental sensoric
M3 controller
M4 light emitting unit
ML4 light
M5 concave lens
ML5 further shaped light
M6 projection optics
ML6 resulting light distribution
G20, M20 headlight
G2 environmental sensoric
G3 controller
G4 controller
G5 lighting device
GL5 light generated by GL5
G6 system of micromirrors
GL6 lighting pattern
G7 projection optics
GL7 light
GL7A, GL7B, GL7C lighting pattern
Pₘₐₓ, Pₘᵢₙ light power
PTC temperature sensor
PS press station
PO upper press unit
PU lower press unit
SPLT gap
OF, OF1 upper mold
UF, UF1 lower mold
UFT1, UFT2 lower mold part
U10, O10 actuator
U11, U12 movable connector
U51, U52 movable guide rods
UO fixed guide element
O11 actuator-side connector
O12 movable guide element
O14 mold-side connector
O51, O52 fixed guide rods
P811, P812 reinforcement profile
SP811, SP812,
SP814, SP815 clamps
ΔKIPOF, ΔKIPUF maximum tilting
ACHSOF, ACHSUF actual pressing direction
ACHSOF*, ACHSUF* target pressing direction
ΔVEROF, ΔVERUF
ENTR ring
ENTS1, ENTS2 discs
BALG bellows
T1 preform
T2, T3 clamping devices
T4 clamping arrangement

1.-16. (canceled)

17. A method for producing an optical element, the method comprising:
providing a blank of glass;
heating the blank of glass;
subsequently press-molding the blank between an upper mold and a lower mold to form an intermediate molded part;
subsequently removing the intermediate molded part from the lower mold by means of the upper mold;
subsequently heating a surface of the intermediate molded part formed by the lower mold;
subsequently press-molding the intermediate molded part to form the optical element; and
subsequently cooling the optical element in a cooling path.

18. The method of claim 17, wherein a vacuum is provided in a channel of the upper mold for removing the intermediate molded part from the lower mold by means of the upper mold.

19. The method of claim 17 further comprising: holding the intermediate molded part by means of the upper mold when heating the surface of the intermediate molded part formed by the lower mold.

20. The method of claim 17, wherein the blank is heated in such a manner that the temperature difference between a bottom side of the blank and a top side of the blank is not more than 100 K immediately before press-molding.

21. The method of claim 20, wherein the lower mold comprises a first lower mold part and at least one second lower mold part enclosing the first lower mold part.

22. The method of claim 21 further comprising: transporting the blank on the first lower mold part to the press for press-molding.

23. The method of claim 21, the method further comprising:
providing a housing; and
transporting the blank on the first lower mold part in the housing to the press for press-molding.

24. The method of claim 17, wherein the lower mold comprises a first lower mold part and at least one second lower mold part enclosing the first lower mold part.

25. The method of claim 24, the method further comprising: transporting the blank on the first lower mold part to the press for press-molding.

26. The method of claim 24, the method further comprising:
providing a housing; and
transporting the blank on the first lower mold part in the housing to the press for press-molding.

27. The method of claim 19, wherein the blank is heated in such a manner that the temperature difference between a bottom side of the blank and a top side of the blank is not more than 100 K.

28. The method of claim 27, wherein press-molding the intermediate molded part to form the optical element is carried out by means of the upper mold.

29. The method of claim 28, wherein press-molding the intermediate molded part to form the optical element is carried out by means of the upper mold and the lower mold.

30. The method of claim 29, wherein the lower mold comprises a first lower mold part and at least one second lower mold part enclosing the first lower mold part.

31. The method of claim 30, the method further comprising: transporting the blank on the first lower mold part for press-molding.

32. The method of claim 17, wherein the lower mold is concavely shaped, and wherein the blank has a radius of curvature that is larger than a radius of curvature of the concavely shaped lower mold.

33. A method for producing a vehicle headlight lens, the method comprising:
heating a blank of glass in such a manner that the temperature difference between a bottom side of the blank and a top side of the blank is not more than 100 K;
subsequently press-molding the blank between an upper mold and a lower mold to form an intermediate molded part;
subsequently removing the intermediate molded part from the lower mold;
subsequently heating a surface of the intermediate molded part formed by the lower mold;
subsequently press-molding the intermediate molded part to form the headlight lens; and
subsequently cooling the headlight lens in a cooling path.

34. The method of claim 33, wherein the lower mold comprises a first lower mold part and at least one second lower mold part enclosing the first lower mold part.

35. The method of claim 34, the method further comprising: transporting the blank on the first lower mold part to the press for press-molding.

36. The method of claim 33, wherein press-molding the intermediate molded part to form the headlight lens is carried out by means of the upper mold.

37. The method of claim 33, wherein press-molding the intermediate molded part to form the headlight lens is carried out by means of the upper mold and the lower mold.

38. A method for producing a vehicle headlight lens, the method comprising:
heating a blank of glass;
press-molding the blank between an upper mold and a lower mold to form an intermediate molded part, wherein the lower mold comprises a first lower mold part and at least one second lower mold part enclosing the first lower mold part;
removing the intermediate molded part from the lower mold;
heating a surface of the intermediate molded part formed by the lower mold;
press-molding the intermediate molded part to form the headlight lens; and
cooling the headlight lens in a cooling path.

39. The method of claim 38, the method further comprising: transporting the blank on the first lower mold part to the press for press-molding.

40. The method of claim 38, the method further comprising:
providing a housing; and
transporting the blank on the first lower mold part in the housing to the press for press-molding.

41. The method of claim 33, wherein press-molding the intermediate molded part to form the headlight lens is carried out by means of the upper mold.

42. The method of claim 33, wherein press-molding the intermediate molded part to form the headlight lens is carried out by means of the upper mold and the lower mold.
